(19) United States
(12) Patent Application Publication
(10) Pub. No.: US 2026/0359032 A1
(43) Pub. Date: Nov. 12, 2026

(54) ORCHESTRATING DYNAMIC SOFTWARE UPGRADES USING ON-DEVICE AGENTIC ARTIFICIAL INTELLIGENCE AND CENTRALIZED CONTROLLER

(71) Applicant: Cisco Technology, Inc., San Jose, CA (US)

(72) Inventors: Pavankumar Bandanakanti, Research Triangle Park, NC (US); Gokulakrishna Pushpala Haribabu, Frisco, TX (US); Katrin Suzanne Gamble, Littleton, CO (US); David John Zacks, Vancouver (ON)

(21) Appl. No.: 19/204,420

(22) Filed: May 9, 2025

(51) Int. Cl. G06F 8/65

(52) U.S. Cl. CPC G06F 8/65

(57) ABSTRACT

A controller orchestrates device upgrades in coordination with upgrade agents operating locally on the devices to be upgraded. The controller generates device-specific upgrade readiness rulesets, which the upgrade agents evaluate periodically using local telemetry data to determine upgrade readiness states for the devices. The controller sends instructions to initiate upgrades to devices with positive upgrade readiness states in line with an upgrade plan that accounts for dependencies among the devices. Upgrade agents can pause upgrades if anomalous activity causes a rule of the respective ruleset to fail when evaluated. The controller and upgrade agents include agentic artificial intelligence services that conduct dynamic upgrade operations.

### TECHNICAL FIELD

The present disclosure relates generally to updating computing devices. More particularly, the present disclosure relates to dynamically updating software on computing devices based on data analysis by agentic artificial intelligence.

### BACKGROUND

Computing devices that execute software applications often receive upgrades to those software applications. Installing upgrades often impacts the performance of computing devices, such as temporarily rendering unavailable some or all functionality. As such, upgrading software applications can be especially problematic when those software applications are being used the most heavily, such as during a peak usage hour of the day. Software upgrading can be further complicated in computing environments that include many computing devices with software upgrades to install, as dependencies among the computing devices can cause major disruptions. For example, installing a software upgrade on a core computing device can disrupt functionality not only on the core computing device, but also on various other computing devices dependent on the core computing device to operate properly.

Existing techniques for managing upgrades are often static and fail to account for changing conditions within a computing environment. Those changing conditions often cause the deployment of upgrades to create operational risks, business disruptions, or other issues, as the existing techniques cannot autonomously adapt to issues that arise in real time-neither locally on a computing device, nor generally within the computing environment.

### SUMMARY OF THE DISCLOSURE

Systems and methods for dynamic upgrading in accordance with embodiments of the disclosure are described herein. In various embodiments, a network device may include a processor and a non-transitory computer-readable storage medium. The storage may be coupled to the processor and may include a logic configured to perform operations when executed by the processor. The logic may be configured to receive, from a controller, an upgrade readiness ruleset, wherein the upgrade readiness ruleset comprises a plurality of upgrade readiness rules; evaluate, by an upgrade agent local to the network device, the upgrade readiness ruleset based on local telemetry data of the network device, resulting in an upgrade readiness state, wherein the evaluating is performed periodically by the upgrade agent; report, by the upgrade agent, to the controller, the upgrade readiness state; receive, from the controller, instructions to initiate an upgrade; determine, by the upgrade agent, based on a subsequent periodic evaluation of local telemetry data, that current local telemetry data fails to satisfy a particular upgrade readiness rule of the plurality of upgrade readiness rules; and responsive to determining that current local telemetry data fails to satisfy the particular upgrade readiness rule, pause, by the upgrade agent, the upgrade.

In various embodiments, the operations further include reporting, by the upgrade agent, to the controller, the pause of the upgrade; determining, by the upgrade agent, at a second subsequent periodic evaluation of local telemetry data, that all upgrade readiness rules of the upgrade readiness ruleset are satisfied, resulting in a new upgrade readiness state; reporting, by the upgrade agent, to the controller, the new upgrade readiness state; receiving, by the upgrade agent, from the controller, new instructions to initiate the upgrade; and responsive to receiving the new instructions to initiate the upgrade and the satisfaction of all upgrade readiness rules, initiating, by the agent, the upgrade on the network device.

In various embodiments, evaluating, by the upgrade agent local to the network device, the upgrade readiness ruleset based on the local telemetry data of the network device, resulting in the upgrade readiness state, comprises monitoring, by the upgrade agent, at least one of critical user traffic and critical application traffic, wherein the upgrade readiness ruleset identifies at least one of a user and an application as critical. Also, determining, by the upgrade agent, based on the subsequent periodic evaluation of the local telemetry data, that the current local telemetry data fails to satisfy the particular upgrade readiness rule of the plurality of upgrade readiness rules, comprises at least one of determining, by the upgrade agent, that the at least one of critical user traffic and critical application traffic is currently traversing the device, and predicting, by the upgrade agent, that the at least one of critical user traffic and critical application traffic will occur within a period of time that fails a timing requirement of the particular upgrade readiness rule.

In various embodiments, determining, by the upgrade agent, based on the subsequent periodic evaluation of the local telemetry data, that the current local telemetry data fails to satisfy the particular upgrade readiness rule of the plurality of upgrade readiness rules, comprises predicting, by the upgrade agent, an amount of time necessary to install the upgrade on the network device; and determining, by the upgrade agent, based on a timing requirement included in the particular upgrade readiness rule, that installing the upgrade would fail to satisfy the timing requirement.

In various embodiments, evaluation of the particular upgrade readiness rule of the upgrade readiness ruleset is based on a dynamic baseline value determined by the upgrade agent based on historic local telemetry data of the network device. In various embodiments, the dynamic baseline value corresponds to one of a central processing unit (CPU) usage, a transitory memory usage, and a non-transitory storage medium usage; and wherein determining, by the upgrade agent, based on the subsequent periodic evaluation of the local telemetry data, that the current local telemetry data fails to satisfy the particular upgrade readiness rule of the plurality of upgrade readiness rules, comprises determining, by the upgrade agent, whether a current usage of one of the CPU, transitory memory, and non-transitory storage medium exceeds the dynamic baseline value by at least a threshold amount.

In various embodiments, the particular upgrade readiness rule comprises a peer availability requirement, the peer availability requirement is failed if a peer device is down, and determining, by the upgrade agent, based on the subsequent periodic evaluation of the local telemetry data, that the current local telemetry data fails to satisfy the particular upgrade readiness rule of the plurality of upgrade readiness rules, comprises determining, by the upgrade agent, that the peer device is down.

In various embodiments, the upgrade agent comprises an agentic artificial intelligence service operating locally on the network device. In various embodiments, the operations further comprise evaluating, by the upgrade agent, at least some of the operations performed by the processor; and adjusting, by the upgrade agent, based on the evaluating the at least some of the operations, one or more parameters of the upgrade agent.

In various embodiments, a device upgrade controller includes a processor and a non-transitory computer-readable storage medium having stored thereon logic that, when executed by the processor, causes performance of operations comprising receiving administrator instructions to upgrade a plurality of computing devices in a computing environment; generating, based on the administrator instructions and device-specific details of the plurality of computing devices, a plurality of upgrade readiness rulesets corresponding to the plurality of computing devices; distributing the plurality of upgrade readiness rulesets to the plurality of computing devices; receiving, from a plurality of upgrade agents local to the plurality of computing devices, respective upgrade readiness states, wherein the plurality of upgrade agents evaluate the plurality of upgrade readiness rulesets based on local telemetry data of the plurality of computing devices; generating, based on the received upgrade readiness states, initial upgrade deployment instructions; and sending, to at least one computing device of the plurality of computing devices, the initial upgrade deployment instructions.

In various embodiments, the operations further comprise receiving one or more subsequent upgrade readiness states from one or more computing devices of the plurality of computing devices; adjusting the initial upgrade deployment instructions based on the received one or more subsequent upgrade readiness states, resulting in adjusted upgrade deployment instructions; and sending, to a particular computing device of the plurality of computing devices, the adjusted upgrade deployment instructions.

In various embodiments, generating, based on the received upgrade readiness states, the initial upgrade deployment instructions, comprises determining, based on the device-specific details, that a first computing device and a second computing device of the plurality of computing devices cannot be down simultaneously, wherein the initial upgrade deployment instructions are sent to the first computing device and not to the second computing device, and wherein the operations further comprise receiving, from the first computing device, a message indicating the upgrade is complete; and subsequent to receiving the message from the first computing device, sending, to the second computing device, upgrade deployment instructions.

In various embodiments, the operations further include generating an upgrade progress visualization that comprises a plurality of graphical elements representing the plurality of computing devices, a plurality of graphical elements representing the upgrade readiness states, and a plurality of graphical elements corresponding to the plurality of computing devices and each indicating whether the respective computing device has successfully installed the upgrade; presenting the generated visualization on a display; and updating the visualization periodically based on subsequent upgrade readiness states.

In various embodiments, the device-specific details of each of the plurality of computing devices comprise one or more of a device type, a device placement, a device use case, and a set of dependencies of the device.

In various embodiments, the operations further include receiving, from the plurality of upgrade agents, topological device-specific details comprising topological telemetry data indicating peer connections among the plurality of computing devices; and identifying, based on the topological device-specific details, a set of dependencies among the plurality of computing devices; wherein generating, based on the received upgrade readiness states, the initial upgrade deployment instructions, is further based on the set of dependencies.

In various embodiments, the device upgrade controller comprises an agentic artificial intelligence service operating locally on the device upgrade controller, the operations further comprising evaluating, by the device upgrade controller, at least some of the operations performed by the processor; and adjusting, by the device upgrade controller, based on the evaluating the at least some of the operations, one or more parameters of the agentic artificial intelligence service.

In various embodiments, a network system includes a device upgrade controller, the device upgrade controller comprising a first processor and a non-transitory computer-readable storage medium having stored thereon logic that, when executed by the first processor, causes performance of control operations comprising generating a plurality of upgrade readiness rulesets corresponding to a plurality of computing devices, wherein each upgrade readiness ruleset of the plurality of upgrade readiness rulesets comprises a plurality of upgrade readiness rules; distributing the plurality of upgrade readiness rulesets to the plurality of computing devices; receiving upgrade readiness states from the plurality of computing devices; generating, based on the upgrade readiness states, upgrade deployment instructions; receiving a subsequent upgrade readiness state from a particular computing device of the plurality of computing devices; and adjusting the upgrade deployment instructions based on the subsequent upgrade readiness state. The network system also includes the plurality of computing devices, wherein each computing device of the plurality of computing devices comprises a respective processor and a non-transitory computer-readable storage medium having stored thereon logic that, when executed by the respective processor, causes performance of agent operations comprising evaluating, by an upgrade agent local to the computing device, a corresponding upgrade readiness ruleset of the plurality of upgrade readiness rulesets, based on local telemetry data of the computing device, resulting in an upgrade readiness state, wherein the evaluating is performed periodically by the upgrade agent, resulting in periodic upgrade readiness states; and reporting, by the upgrade agent, the periodic upgrade readiness states to the device upgrade controller.

In various embodiments, generating the upgrade deployment instructions comprises identifying, based on a topology of the network system, that a particular application is accessible only through a subset of computing devices of the plurality of computing devices; generating a first set of upgrade deployment instructions excluding at least one computing device of the subset of computing devices; and responsive to determining that the subset of computing devices, besides the at least one computing device, upgraded successfully, generating a second set of upgrade deployment instructions for the at least one computing device.

In various embodiments, for each computing device of the plurality of computing devices, the evaluating the corresponding upgrade readiness ruleset comprises, for each upgrade readiness rule of the upgrade readiness ruleset, determining whether corresponding local telemetry data of the computing device satisfies the upgrade readiness rule; wherein satisfaction of all upgrade readiness rules of the upgrade readiness ruleset corresponds to a positive upgrade readiness state indicating the network device is ready to install the upgrade; and wherein satisfaction of fewer than all upgrade readiness rules of the upgrade readiness ruleset corresponds to a negative upgrade readiness state indicating the network device is not ready to install the upgrade.

In various embodiments, each upgrade agent is containerized on a respective computing device of the plurality of computing devices.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a dynamically upgrading computing environment in accordance with various embodiments of the disclosure.

FIG. 2 is a schematic block diagram of a network device in accordance with various embodiments of the disclosure.

FIG. 3 is a diagram depicting various subsets of artificial intelligence in accordance with various embodiments of the disclosure.

FIG. 4 is an illustration of different methods of machine-based learning in accordance with various embodiments of the disclosure.

FIG. 5 is an illustration of a machine learning lifecycle in accordance with various embodiments of the disclosure.

FIG. 6 is an exemplary neural network in accordance with various embodiments of the disclosure.

FIG. 7 is a flowchart depicting a process of a local upgrade agent in accordance with various embodiments of the disclosure.

FIG. 8 is a flowchart depicting a process of a device upgrade controller in accordance with various embodiments of the disclosure.

FIG. 9 is a conceptual block diagram of a device suitable for configuration with upgrade logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

Organizations face substantial challenges and operational risks when upgrading on-premises network devices and servers. Existing upgrade techniques typically follow predetermined steps that fail to adequately account for contingencies or critical dependencies among applications and network resources. Existing techniques also lack the capability to effectively utilize historical data, usage patterns, log files, and interface statistics, making it difficult to predict potential issues. Additionally, current techniques cannot dynamically adapt upgrade strategies based on real-time data, such as overly high central processing unit (CPU) usage, leading to inefficiencies, business disruptions, and a general lack of informed decision-making and contingency planning. Furthermore, contemplated attempts to intelligently orchestrate upgrade deployments by centrally streaming telemetry data from multiple devices could often become impractical or impossible due to the overwhelming volume of telemetry data to be processed, significantly limiting the scalability and reliability of the technique.

Various techniques described herein orchestrate device upgrades using a combination of a centralized controller, e.g., a device upgrade controller, and local agents, e.g., upgrade agents at each device to be upgraded. The controller has domain-wide knowledge, and can adapt to changing conditions across the computing environment. For example, the controller may be aware that a critical service is only accessible through two network switches, and therefore implements an upgrade plan that does not initiate the upgrade on one of the two network switches until the other has completed its upgrade, better ensuring the critical service remains accessible over the network on which the upgrades are being deployed. The controller distributes device-specific upgrade readiness rulesets to agents at devices to be upgraded. The agents evaluate the rulesets, using local telemetry data to determine whether upgrade readiness rules in the rulesets are satisfied, and periodically check in with the controller by sending the controller upgrade readiness states. Upgrade readiness states indicate whether the device on which the agent operates satisfies all the rules of the respective ruleset, and therefore is ready to upgrade. In this manner, the controller remains aware of which devices are ready to upgrade and which are not, and can dynamically adjust the upgrade plan accordingly. For example, if a current upgrade plan has a particular device initiating the upgrade in one minute, but the particular device reports it is not ready to upgrade, the controller can alter the upgrade plan such that a different device initiates the upgrade. Various embodiments of the techniques described herein may provide some or all of the benefits described above, as well as benefits not explicitly described herein, by employing some or all of the techniques described above, and/or similar techniques that do not depart from the scope and spirit of those described herein.

In this manner, the various techniques put forth herein provide for dynamically adjusting device upgrading that can adapt to changing conditions, both at the device level and at the environment-wide level. By processing telemetry data locally at the devices to be upgraded, the techniques provide networking efficiencies while simultaneously providing for real-time or near real-time monitoring of conditions at the device, enabling the system to minimize risks presented by upgrading devices. The networking efficiencies provided by processing telemetry data locally, such as avoiding the streaming of telemetry data to a central controller for processing, allows the techniques described herein to reduce network traffic, and also increase the number of devices over which upgrades can be orchestrated simultaneously, as there is no bottleneck of streaming data to one location for processing and decision-making. The environment-wide knowledge at the controller, based on upgrade readiness states received from the devices to be upgraded, enable the controller to minimize risks posed by upgrading devices, such as avoiding the simultaneous upgrading of all devices that provide access to a particular critical service, or which are transporting critical traffic. Generally, the techniques described herein provide networking efficiencies by minimizing the network traffic needed for dynamically adjusting device upgrading, minimize the risks posed by upgrading, and avoid bottlenecks that limit the number of devices for which upgrades can be orchestrated, thereby increasing the total number of devices that can be intelligently upgraded together.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in-one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

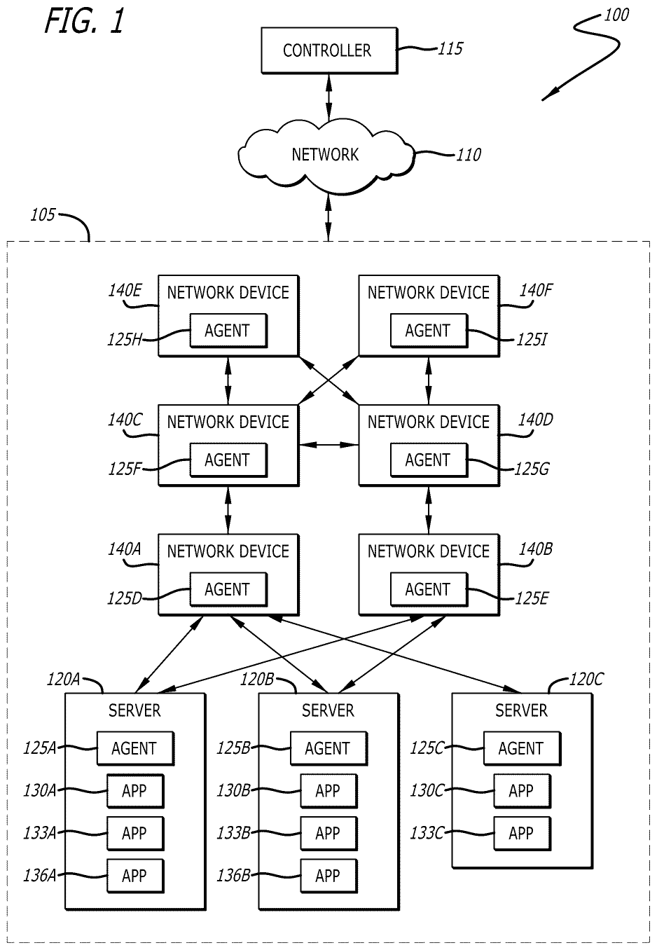

Referring to FIG. 1, a schematic block diagram of a dynamically upgrading computing environment (shown as environment 100) in accordance with various embodiments of the disclosure is shown. The environment 100 includes a local area network (shown as LAN 105), a network 110, and a controller 115. In other embodiments the environment 100 can include additional, fewer, or other elements, such as a firewall device, and/or a user device of an administrator, e.g., an administrator that uses the user device to send instructions to the controller 115 or that receives graphical user interfaces (“GUIs”) from the controller for display. A person of skill in the art will recognize that the techniques described herein can apply to an environment 100 that is different without departing from the principles set forth herein, such as embodiments where the environment 100 includes the controller 115 within the LAN 105, or where the LAN 105 is instead an enterprise network or other group of computing devices, or so on. For purposes of clarity, FIG. 1 is described below solely with reference to a LAN 105, but a person of skill in the art will recognize that the described techniques can apply to any other group of communicatively coupled computing devices.

The network 110 is any combination of wired and/or wireless communication systems that communicatively couple the controller 115 to the LAN 105. In various embodiments, the network 110 comprises the internet and/or any combination of local area and/or wide area networks. In various embodiments, the network 110 is or is part of the LAN 105, e.g., in embodiments where the controller 115 is not remote from the computing devices of the LAN 105. In various embodiments, the network 110 uses standard communications technologies and/or protocols. For example, the network 110 can include communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 110 can include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 110 may be represented using any suitable format, such as hypertext markup language (HTML) or extensible markup language (XML). In some embodiments, all or some of the communication links of the network 110 may be encrypted using any suitable technique or techniques.

The controller 115 is a computing device, such as a server, that performs device upgrade operations. In various embodiments, the controller 115 executes control logic to perform device upgrade operations. The control logic can include various functionality, depending upon the embodiment, including some or all functionality described herein. Depending on the embodiment, the controller 115, e.g., a device upgrade controller, orchestrates upgrades for one or more devices in the LAN 105. The controller 115 receives administrator instructions, e.g. from a user device of an administrator, which may be part of the LAN 105. In some embodiments, the user device of the administrator and/or controller 115 are part of the LAN 105. In other embodiments, the user device of the administrator and/or controller 115 are remote from the LAN 105 and communicate with the LAN 105 over the network 110.

The administrator instructions initiate an upgrade session and include parameters for the upgrade session. An upgrade session is an instance of the controller 115 and one or more agents, described in further detail below, orchestrating and implementing dynamic device upgrades for one or more devices in the LAN 105. The controller 115 and one or more agents implement an upgrade plan generated by the controller 115. The controller 115 generates the upgrade plan based on the administrator instructions, and can alter the upgrade plan based on data received from the one or more agents as well as further instructions received from the administrator. In various embodiments, the administrator can send additional instructions to the controller 115 during an upgrade session, which the controller 115 and/or one or more agents obey. For example, during an upgrade session, the administrator may send the controller 115 instructions to pause or cancel the upgrade session, or to add or remove devices from the upgrade session. The controller 115 receives these additional instructions and adapts accordingly.

The administrator instructions can include any of a variety of parameters, depending upon the embodiment. The instruction parameters can include indications of devices to upgrade, such as a list of one or more devices in the LAN 105 to upgrade during an upgrade session initiated by the administrator instructions. The instruction parameters can include details of the upgrade to be deployed at the one or more devices to be upgraded, such as one or more data files comprising the upgrade, indications of a portion of each device to upgrade (such as identifiers for or paths to one or more applications or services at the device), and/or so on. Various instruction parameters are described below. A person of skill in the art will recognize that other instruction parameters can be included in the administrator instructions without departing from the principles set forth herein. The instruction parameters can include device-specific constraints, which can be constraints based on device-specific details of the devices to be upgraded. As such, one or more device-specific constraints in administrator instructions may apply to a subset of devices to be upgraded in an upgrade session, e.g., devices with details that match the device-specific constraints. Device-specific constraints can include constraint details that the controller 115 can match to device data to determine whether a device is to be constrained by the device-specific constraints. For example, the constraint details can be a device placement (e.g., geographic location), a device type (e.g., a router, a switch, a server), a device use case (e.g., a core switch, a distribution switch, an access switch), and/or a set of dependencies of the device (e.g., topological network dependencies where the normal operation of one device depends on the functioning of at least one of a set of other devices, e.g., a set of other devices that expose a particular application or service).

Device-specific constraints can include time constraints for one or more devices. For example, the time constraints can specify windows of time, e.g., hours of the day, days of the week, days of the year (e.g., holidays), and/or so on, during which the corresponding devices cannot be upgraded. The instruction parameters can include traffic constraints, such as critical user or critical application constraints. For example, a critical user constraint can include a user identifier, such as a username, media access control (MAC), or internet protocol (IP) address, where devices connected to an active session with the user identifier, or which are transporting traffic to or from the user identifier, cannot be upgraded until the user disconnects or traffic of the user ceases to traverse the device. As another example, critical application constraints can include an application identifier, such as an application user model identifier (AUMID) or bundle identifier (Bundle ID), where all devices exposing the application identified by the application identifier cannot be upgraded simultaneously, or where devices transporting traffic to or from the application cannot be upgraded until the traffic ceases. The instruction parameters can include geographic constraints, such as a constraint that limits the upgrade to devices at a specific geographic designation, such as devices within a particular floor of a building or data center, within a particular building or data center, city, state, country, continent, and/or so on.

The instruction parameters can also include computing resource constraints, as described in further detail below. Depending on the embodiment, the computing resource constraints can include one or more of a central processing unit (CPU) usage, a graphics processing unit (GPU) usage, a transitory memory (e.g., random-access memory (“RAM”)) usage, a non-transitory storage medium (e.g., hard disk drive, solid state drive (SSD), magnetic tape, and/or optical disc) usage, and a link usage (e.g., cables, such as twisted pair cables, coaxial cables, fiber optic cables, and/or ethernet cables; buses, such as universal serial buses (USB); and/or interfaces, such as digital visual interfaces (DVI) and/or high-definition multimedia interface (HDMI)). In various embodiments, the instruction parameters can include a maximum usage constraint for one or more computing resources and/or a dynamic usage constraint.

A maximum usage constraint is a usage limit, where the device cannot upgrade when usage of the computing resource above the limit. For example, a CPU or processor maximum usage constraint may be 75%, where the upgrade cannot initiate on a device if the CPU usage of the device is above 75% and/or is expected to go above 75% within a certain amount of time, such as an estimated upgrade install time. As described in further detail below, determining expected computing resource usage and/or estimated upgrade install time can be performed by an agent and/or the controller 115.

A dynamic usage constraint can be considered by those skilled in the art as a range around a dynamic baseline value where the device cannot upgrade when the usage of the constrained computing resource is outside the range or predetermined threshold amount. For example, a particular dynamic CPU or processor usage constraint may be defined as within 20% of a dynamic CPU usage baseline, where the range can be above and/or below the dynamic CPU usage baseline depending on the embodiment. To continue the example, the upgrade cannot initiate on a device if the CPU usage of the device is more than 20% deviated from the dynamic baseline and/or is expected to exceed the range of 20% above and/or below the dynamic baseline within a certain amount of time, such as an estimated upgrade install time. In various embodiments, as described in further detail below, an agent corresponding to a device determines the dynamic CPU usage baseline based on historic and/or current telemetry data of the device.

Based on the administrator instructions, the controller 115 generates one or more upgrade readiness rulesets. In various embodiments, the controller 115 generates device-specific upgrade readiness rulesets, e.g., a respective upgrade readiness ruleset for each device to be upgraded in the upgrade session, based on details of the devices. For example, the administrator instructions can include one or more device-specific constraints, e.g., one or more of the device-specific constraints described above. For each device-specific constraint and each device, the controller 115 determines whether details of the device match the device-specific constraint, and if so, generates an upgrade readiness rule based on the device-specific constraint parameters for the device that is included in the device's respective upgrade readiness ruleset. Upgrade readiness rulesets can also include rules common to all devices in the upgrade session, such as upgrade readiness rules based on computing resource usage constraints. The controller 115 distributes the upgrade readiness rulesets to the devices to be upgraded, e.g., to agents on the devices. For example, each device-specific upgrade readiness ruleset is sent by the controller 115 to an agent at the device corresponding to the device-specific upgrade readiness ruleset.

The controller 115 receives upgrade readiness states from the devices included in the upgrade session. Depending on the embodiment, the agents at the devices register with the controller 115, which can include reporting receipt of an upgrade readiness ruleset. Upon registration, the agents and controller 115 communicatively couple, e.g., establish a secure shell (“SSH”) tunnel from each agent to the controller 115, forming a feedback loop used for dynamic upgrading. The agents at the devices each evaluate the respective upgrade readiness ruleset, as described in further detail below, and based on the evaluation generate an upgrade readiness state. The agents report the upgrade readiness states to the controller 115. Depending on the embodiment, the controller 115 may receive upgrade readiness states periodically, such as approximately every five seconds, every fifteen seconds, every thirty seconds, every minute, every five minutes, every fifteen minutes, and/or so on. The controller 115 receiving upgrade readiness states periodically corresponds to the agents at the devices evaluating the upgrade readiness rulesets periodically and generating and reporting respective periodic upgrade readiness states to the controller 115, as described in further detail below.

Based on the upgrade readiness states, the controller 115 can adjust the upgrade plan for the upgrade session. Depending on the embodiment, the upgrade plan is a schedule for upgrading the devices to be upgraded, and can include devices to be upgraded at the present moment, devices to be upgraded imminently (e.g., when one or more currently upgrading devices finish upgrading, and/or within a certain amount of time, such as five minutes), and/or all devices to be upgraded. In various embodiments, the controller 115 does not instruct devices to upgrade when those devices correspond to negative upgrade readiness states. Upgrade readiness states are either positive or negative, and in various embodiments comprise a binary flag. A positive upgrade readiness state indicates the device is ready to install the upgrade and corresponds to satisfaction or fulfilment of all upgrade readiness rules of the upgrade readiness ruleset of the device; a negative upgrade readiness state indicates the device is not ready to install the upgrade and corresponds to satisfaction or fulfilment of fewer than all upgrade readiness rules of the upgrade readiness ruleset of the device. The controller 115 may adjust the upgrade plan based on upgrade readiness states throughout the course of the upgrade session, e.g., based on any periodically received upgrade readiness state(s). For example, a current upgrade plan may include a particular device as the next device to be upgraded; if the controller 115 receives a negative upgrade readiness state from the particular device, the controller 115 adjusts the upgrade plan such that a different device (e.g., one corresponding to a positive upgrade readiness state) is set as the next device to be upgraded. Based on the upgrade plan, the controller 115 sends upgrade instructions to agents at devices, e.g., identifies a next device to be upgraded and sends upgrade instructions to the agent at that device. The upgrade instructions can include the details of the upgrade, such as the data files of the upgrade, and can include a particular time at which to initiate the upgrade at the device.

In various embodiments, the controller 115 can generate the upgrade plan based on the topological data of the LAN 105. In some embodiments, this can include identifying sets of devices in the LAN 105 that cannot be down simultaneously, e.g., cannot install the upgrade simultaneously. For example, in certain embodiments a set of devices may be all devices in the LAN 105 that expose a particular application or service. If all the devices in the set of devices are down, the application or service may not be reachable, disrupting operations of the LAN 105 and potentially posing business and/or cybersecurity risks. In some embodiments, the controller 115 may receive from each agent indications of peer devices, e.g., devices to which the device running the agent is connected. Based on the indications, the controller 115 maps the LAN 105 and evaluates device-specific constraints, specifically dependency-related constraints, to identify the sets of devices. For example, the administrator instructions may identify a particular application as critical. The controller 115 determines which devices in the LAN 105 provide access to the critical application, and groups those devices. The controller 115 constrains its generation of the upgrade plan such that not all devices in the group are upgraded simultaneously, thereby reducing the risk of the LAN 105 losing access to the critical application during the upgrade session. As another example, the group may include two devices, and the controller 115 may instruct one of the two devices to upgrade, and only upon receiving a message from the one device that it has finished installing the upgrade and is back up will the controller 115 instruct the other of the two devices to initiate the upgrade.

In various embodiments, the controller 115 generates an upgrade progress visualization that tracks completion of the upgrade session. The controller 115 may send the upgrade progress visualization to a user device, such a user device of the administrator, for display. Depending on the embodiment, the upgrade progress visualization can include any number or variety of graphical elements. In some embodiments, the upgrade progress visualization includes graphical elements representing the computing devices involved in the upgrade session (e.g., identified by the administrator instructions as devices to be upgraded). In some embodiments, the upgrade progress visualization includes graphical elements representing the upgrade readiness states, such as, for each device, a graphical element indicating a most recent upgrade readiness state. For example, the graphical elements representing the computing devices may include a geometric shape, and the graphical elements representing the upgrade readiness states can be colors within the geometric shapes of the corresponding computing devices. In some embodiments, the upgrade progress visualization includes graphical elements corresponding to the computing devices and each indicating whether the respective computing device has successfully installed the upgrade, such as a graphical check mark next to a geometric shape representing a computing device that has completed the upgrade. In some embodiments, the upgrade progress visualization can include one or more analytics determined by the controller 115, such as a percentage of devices that have completed the upgrade, and/or an elapsed time of the upgrade session, and/or an estimated remaining time of the upgrade session.

In various embodiments, the controller 115 comprises an agentic artificial intelligence (“AI”) service. Agentic artificial intelligence refers to a class of AI systems designed to operate autonomously, pursue defined goals, and make context-aware decisions without requiring constant human intervention. Such systems incorporate one or more machine learning models along with supporting components that enable the system to perceive inputs (e.g., telemetry data, user behavior, or environmental conditions), process and interpret those inputs using the model, and execute actions based on predefined policies or adaptive logic. An agentic AI system may also include feedback mechanisms that allow it to evaluate the effectiveness of its actions and refine its internal decision-making processes over time, enabling continuous improvement. These systems can be deployed locally on computing devices or network equipment and may operate independently or as part of a coordinated set of distributed agents.

In various embodiments, the controller 115 includes a feedback mechanism to improve one or more operations of the controller 115, such as generation of upgrade readiness rulesets and/or upgrade plans. The feedback mechanism can include determining portions of the upgrade plan where predefined (e.g., by the administrator instructions) errors occurred, such as loss of access to a critical application, and labeling that portion of the corresponding upgrade plan as negative. The agentic AI system can refine its model based on the labeled portion of the corresponding upgrade plan, e.g., adjust one or more parameters, such that a subsequent upgrade plan of a subsequent upgrade session performs differently. For example, based on the feedback mechanism, the agentic AI system may self-refine such that fewer devices of a group of devices collectively exposing access to a critical application are ever simultaneously upgraded, or that the group of devices install the upgrade within more constrained time windows, or so on. In various embodiments, the agentic AI service receives the administrator instructions, generates the upgrade readiness rulesets, receives upgrade readiness states, generates the upgrade plan, adjusts the upgrade plan, sends upgrade instructions, and so on.

The LAN 105 is a set of connected computing devices, such as the computing devices within a building that correspond to a particular organization. Depending on the embodiment, the LAN 105 may be a local area network, or could instead by any other grouping of computing devices, as described above. In some embodiments, the LAN 105 includes the network 110. In the embodiment of the figure, the LAN 105 includes servers 120A-C and network devices 140A-F. A person of skill in the art will recognize that in other embodiments the LAN 105 can include any type and/or number of computing devices arranged in any suitable configuration, such as one or more instances of a network device 140, one or more instances of a server 120, other computing devices such as user devices, and so on, without departing from the principles set forth herein.

The servers 120A-C are computing devices configured to manage resources and respond to requests from other devices over a network (e.g., the LAN 105 and/or network 110). In particular, servers 120 may host and expose one or more software applications, services, or interfaces that are accessible to remote clients via one or more communication protocols. For clarity and conciseness, software applications, services, and interfaces hosted and exposed by the servers 120 are illustrated and described as “apps,” such as app 130, app 133, and app 136. A server may receive, process, and respond to incoming requests, and may also manage state, perform computations, or access underlying databases or storage systems in support of the hosted apps.

Each server 120A-C is a device in the LAN 105 that can be upgraded during an upgrade session orchestrated by the controller 115. In line with this, each server 120 includes an agent 125. As described in further detail below, the agents 125 are services that coordinate with the controller 115 to perform dynamic upgrade operations. The servers 120A-C expose apps, e.g., over the LAN 105 via the network devices 140A-F. Server 120A includes agent 125A, app 130A, app 133A, and app 136A, and is connected to network devices 140A-B. Server 120B includes agent 125B, app 130B, app 133B, and app 136B, and is connected to network devices 140A-B. Server 120C includes agent 125C, app 130C, and app 133C, and is connected to network device 140A.

As an example of the controller 115 orchestrating device upgrades in the LAN 105 to minimize risk, e.g., in view of the topology of the LAN 105, if network device 140B is currently down due to its installing the upgrade, the controller 115 has knowledge of the topology of the LAN 105 and determines that initiating an upgrade at network device 140A would cause the LAN 105 to lose connection to all servers 120A-C, and therefore lose access to the apps 130, 133, 136. As such, the controller 115 may wait until network device 140B finishes upgrading before initiating the upgrade at network device 140A. As such, apps 130, 133, 136 will still be reachable via network device 140B, avoiding disruptions to the normal operation of the LAN 105.

Network device 140A includes agent 125D, network device 140B includes agent 125E, network device 140C includes agent 125F, network device 140D includes agent 125G, network device 140E includes agent 125H, and network device 140F includes agent 125I. The network devices 140A-F are arranged in a traditional three-tier network architecture of a core layer (network devices 140E-F), distribution layer (network devices 140C-D), and access layer (network devices 140A-B). A person of skill in the art will recognize that, depending on the embodiment, a network device 140 included in the LAN 105 can include one or more instances of the network device 140 conforming to any topology. Depending on the embodiment, the administrator instructions can identify any number of network devices and/or servers to be upgraded, including no network devices or no servers.

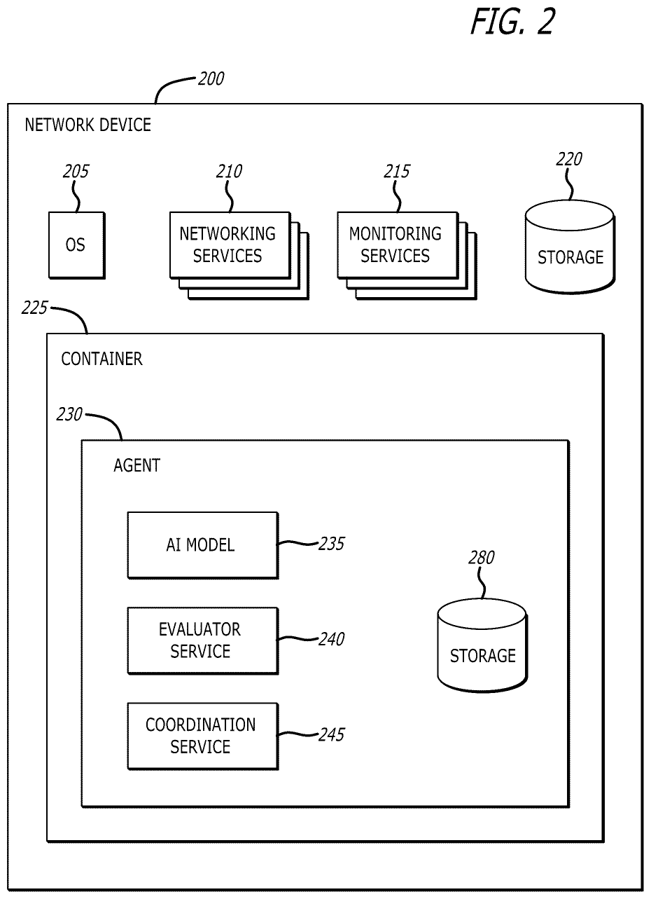

Referring to FIG. 2, a schematic block diagram of a network device 200 in accordance with various embodiments of the disclosure is shown. Although illustrated as solely as a network device for clarity and conciseness of description, in other embodiments the device could be any other computing device, such as a server, and a person of skill in the art will recognize that the principles set forth herein can apply to any other computing device without departing from those principles.

The network device 200 includes an operating system (shown as OS 205), networking services 210, monitoring services 215, storage 220, and container 225. The container 225 includes an agent 230, and the agent 230 includes an artificial intelligence model (shown as AI model 235), an evaluator service 240, a coordination service 245, and a storage 280. In other embodiments, the network device 200 can include additional, fewer, or other elements than those illustrated. For example, in some embodiments, the network device 200 may include a security service, or some or all monitoring services 215 may be part of the agent 230, or the network device 200 may not include the networking services 210, e.g., in embodiments where the network device 200 is instead a server or other computing device. In some unpreferred embodiments, the agent 230 is remote from the network device 200, such as an agent 230 hosted by a remote server communicatively coupled to the network device 200. Furthermore, some or all functionality described herein may be distributed among elements of the network device 200 differently than as described herein without departing from the principles set forth herein.

The OS 205 is specialized software designed to manage and coordinate hardware resources, provide a platform for executing application programs, and enable communication among software and underlying hardware components within computing devices. Particularly for devices such as network switches, routers, and servers, the OS 205 plays a role in managing network operations, device configuration, and data processing tasks. In network switches and routers, the OS 205 can implement functionalities including network interface management, execution of networking protocols, route computation, packet forwarding, security enforcement through access control lists, and handling of control-plane traffic. The OS 205 can also manage hardware resources like CPUs, GPUs, memory, storage devices, and network interfaces, and (particularly for servers) facilitate the hosting and operation of application software and services that are exposed to clients across a network.

Furthermore, an OS 205 on network, server, and/or other computing devices can typically incorporate mechanisms to ensure reliability, performance, scalability, and security, including task scheduling, memory management, fault isolation, logging, and remote management interfaces. In further embodiments, the OS 205 used in networking environments can also support dynamic configuration, telemetry data collection, traffic analysis, and real-time system monitoring, such as playing a role in the operation of monitoring services 215, and in some embodiments can host and run one or more instances of an AI model 235. These capabilities can enable efficient control and optimization of network and computing resources, better ensuring that data communication, resource allocation, and application hosting are conducted in a stable, efficient, and secure manner.

The networking services 210 are one or more services or applications executed by the network device 200. Computing devices in the LAN 105 other than networking devices 200, such as servers, may not include some or all of the networking services 210, and may include one or more other services or applications, depending on the embodiment. Networking services 210 executed by network devices 200, such as switches and routers, are designed to perform various operations depending on the embodiment, such as to facilitate and manage data transfer, device connectivity, and network reliability across computing environments. These networking services 210 typically include implementations of one or more protocols, such as routing protocols like Border Gateway Protocol (BGP) and Open Shortest Path First (OSPF), which determine optimal data transmission paths across networks; switching protocols, including Spanning Tree Protocol (STP) and Link Aggregation Control Protocol (LACP), which manage local data link connections and prevent network loops; and address management protocols, such as Dynamic Host Configuration Protocol (DHCP), which dynamically assign IP addresses and related network configuration parameters. Additionally, in various embodiments, network devices 200 implement one or more security-related services, such as access control lists (ACLs), firewall features, and/or authentication mechanisms (e.g., 802.1X), to secure and control network access and traffic flow.

Further, in various embodiments, network devices 200 such as switches and routers run one or more network management and telemetry services, such as Simple Network Management Protocol (SNMP), NetFlow, sFlow, or streaming telemetry protocols, which collect and transmit operational data to facilitate monitoring, troubleshooting, and analytics. These networking services 210, which are particularly telemetry services, allow for real-time assessment of network conditions, traffic patterns, and performance metrics, enabling administrators to proactively manage network resources, detect anomalies, and optimize system efficiency. Modern network devices 200 may also execute networking services 210 that are more advanced including network virtualization and overlay protocols (e.g., VXLAN with EVPN), quality-of-service (QoS) mechanisms to prioritize critical application traffic, and automation interfaces like NETCONF or REST APIs for remote, programmatic device management.

The monitoring services 215 are one or more services or applications executed by the network device 200. Computing devices in the LAN 105 other than networking devices 200, such as servers, may not include some or all of the monitoring services 215, and may include one or more other monitoring services or applications, depending on the embodiment. In some embodiments, one or more of the monitoring services 215 are part of an agent 230 and may be within a container 225, rather than being external to the container 225 and agent 230 as in the illustrated embodiment.

Monitoring services 215 can include Deep Packet Inspection (DPI), a form of advanced network packet filtering that examines not just the headers of data packets, but also the payload, to perform operations such as identifying protocols, detecting anomalies, classifying traffic types, and/or enforcing security policies. Monitoring services 215 can include Network-Based Application Recognition Version 2 (NBAR2), which operates by classifying application-level traffic using deep packet analysis and heuristic methods, enabling intelligent application visibility and control at granular levels, such as distinguishing and prioritizing mission-critical applications from non-essential traffic.

The monitoring services 215 can also or alternatively include flow-based monitoring technologies such as NetFlow, IPFIX, and sFlow, which provide summarized metadata about network traffic flows, including source and destination addresses, port information, packet counts, and byte volumes, allowing traffic pattern analysis, performance issue troubleshooting, bandwidth usage optimization, and/or security incident detection. NetFlow and similar protocols help identify network usage trends and capacity requirements without the performance overhead associated with full packet capture. Furthermore, Simple Network Management Protocol (SNMP) offers a widely adopted protocol framework for remotely collecting operational metrics from network devices 200, including CPU load, memory utilization, port status, interface statistics, and device uptime. SNMP utilizes management information bases (MIBs), such as the Link Layer Discovery Protocol MIB (LLDP-MIB), to provide structured data representations that facilitate consistent monitoring across diverse devices and manufacturers. The monitoring services 215 can include such SNMP functionality, and/or any other flow-based monitoring technologies, in various embodiments.

The Network Configuration Protocol (NETCONF) and Yet Another Next Generation (YANG) data models represent a more recent generation of management and monitoring protocols, providing structured and programmable interfaces for device configuration, state retrieval, and operational telemetry. NETCONF, leveraging XML-based messaging and YANG-modeled data structures, enables automation of network device 200 management, supports precise configuration tracking, and provides consistent, structured monitoring information. Additionally, device discovery and network topology monitoring protocols such as Cisco Discovery Protocol (CDP) and Link Layer Discovery Protocol (LLDP) operate by periodically exchanging identity, capability, and connection information between directly connected devices. Such protocols assist in dynamically mapping network topology, verifying connectivity, and detecting configuration discrepancies. Depending on the embodiment, the monitoring services 215 can include some or all of the above, and in some embodiments can include monitoring services 215 that are beyond or additional to those described herein, without departing from the principles set forth herein.

The storage 220 is one or more computer-readable non-transitory storage media that stores data of the network device 200 and/or one or more messages, such as packets of network traffic, that traverse the network device 200. The storage 220 stores data in a relational and/or non-relational database and/or other data storage structure, in any of a variety of formats, depending on the embodiment. In various embodiments, the storage 220 may store application data of the OS 205, networking services 210, and/or monitoring services 215. In some embodiments, some or all of storage 220 is part of storage 280, or vice versa.

The container 225 is a software container. Software containers are lightweight, portable, and self-contained software packages that include an application and all of its dependencies, such as libraries, configuration files, runtime environments, and system tools, required for execution in a consistent and isolated manner across various computing environments. In various embodiments, the network device 200 includes a container 225 containing the agent 230. In other embodiments, the agent 230 runs on the network device 200 more directly and is not contained in a container 225. In some embodiments, the agent 230 may be contained by a virtual machine rather than a container 225.

Containers, such as container 225, generally operate by leveraging operating system-level virtualization, typically through features such as namespaces and control groups (cgroups) in Linux-based systems, to isolate the containerized application's processes, file systems, and network stacks from those of other containers and the host system. Unlike virtual machines, which emulate entire hardware stacks and require separate operating systems, containers, such as container 225, share the host operating system kernel, thereby reducing overhead and improving performance and resource efficiency. Containers, such as container 225, are typically defined by an immutable image that specifies its execution environment and behavior, and may be managed by container engines such as DOCKER or container runtimes compliant with the Open Container Initiative (OCI). Containers such as container 225 may be deployed individually or orchestrated in groups by container orchestration platforms such as KUBERNETES, which provide services such as load balancing, scaling, service discovery, and lifecycle management. In distributed systems and network devices, software containers such as container 225 can enable modular, scalable, and rapid deployment of applications, microservices, and monitoring agents, and facilitate consistent behavior across development, testing, and production environments.

The agent 230 is a service running on the network device 200 that executes agent logic to perform device upgrade operations. The agent logic can include various functionality, depending upon the embodiment, including some or all functionality described herein. In some unpreferred embodiments, the agent 230 corresponding to a network device 200 or other computing device is hosted by a separate device rather than the corresponding network device 200 or other computing device. Generally, it is preferrable for computing devices to be upgraded, such as network device 200, to host agents like agent 230 such that the agent 230 can perform operations locally, such as evaluating local telemetry data of the network device 200, without needing to traffic all that telemetry data over the network to another device for evaluation. In this manner, executing the agent 230 locally can reduce the usage of computing resources, avoiding traffic and analytical bottlenecks that can limit the scope of an upgrade session.

In various embodiments, the agent 230 includes an agentic artificial intelligence service that executes agent logic, such as orchestrating device upgrades in concert with the controller 115. Various operations that may be performed by the agent 230, depending on the embodiment, are described below. A person of skill in the art will recognize that other operations not explicitly delimited herein can be part of the agent logic executed by the agent 230 without departing from the principles put forth herein. In various embodiments, the agent 230 includes an AI model 235, an evaluator service 240, and a coordination service 245, as well as a storage 280, which collectively execute the agent logic of the agent 230. Depending on the embodiment, the agent 230 can include additional, fewer, or other elements, and the functionality described herein can be distributed among the elements of the agent 230 differently than as described, without departing from the principles set forth herein.

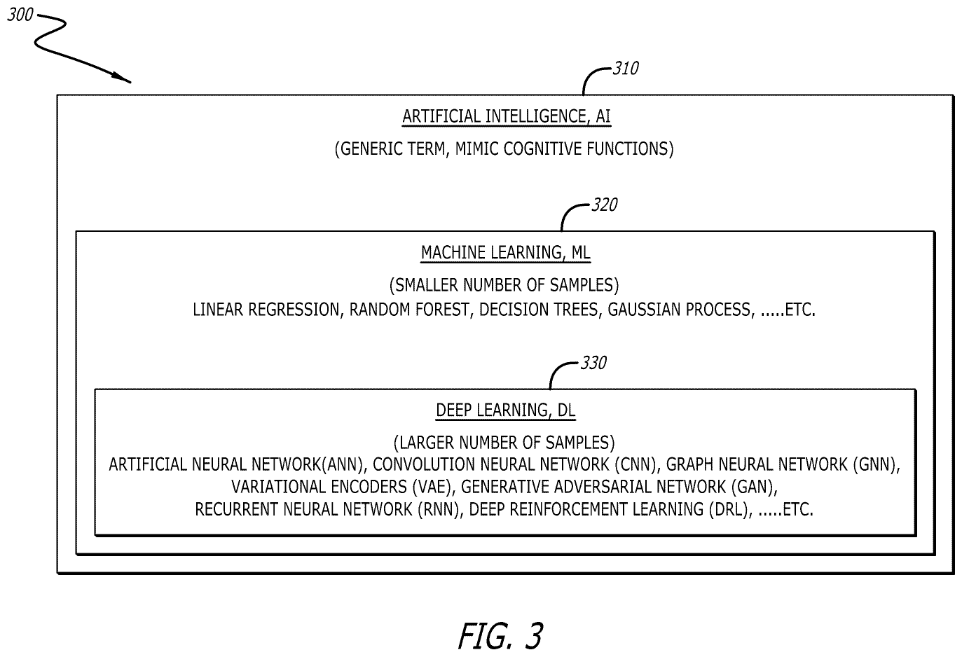

The AI model 235 is a computational construct designed to perform tasks related to device upgrading by learning from data. An AI model typically comprises a defined architecture—such as a neural network, decision tree, or ensemble of algorithms—and a set of learned parameters that are optimized during a training process using historical or simulated data. The model receives input data, processes it through a sequence of mathematical transformations defined by the architecture, and generates an output that represents an inference, decision, or prediction. Various details of AI models, some or all of which may apply to the AI model 235, depending on the embodiment, are described with reference to FIGS. 3-6 below.

In various embodiments, the AI model 235 includes an agentic AI model. An agentic AI model extends the functionality of a traditional AI model by embedding it within a broader framework that enables autonomous, goal-directed behavior. In such systems, the agentic AI model not only performs inference but also evaluates outcomes, adapts strategies, and selects or sequences actions based on dynamic inputs, policies, or feedback. These models are typically integrated into a software agent, such as the agent 230 in various embodiments, that includes sensing components (to collect and preprocess system data), an inference engine (to execute the model), a decision-making module (to evaluate and act on model outputs), and an actuation interface (to perform system-level actions). For clarity and conciseness of description, functionality of the agent 230, including functionality that may be part of the AI model 235, is described with reference to the evaluator service 240 and/or coordination service 245 herein. In various embodiments, some or all logic of the evaluator service 240 and/or coordination service 245 may be part of the AI model 235.

Agentic AI models may further incorporate mechanisms for continuous learning or adaptation, allowing them to refine their behavior over time in response to changing conditions or objectives. In various embodiments, the AI model 235 includes a feedback mechanism to improve one or more operations of the agent 230, such as evaluation of upgrade readiness rulesets and/or evaluation of local device telemetry data. The feedback mechanism can include determining moments during an upgrade session where predefined (e.g., by the administrator instructions) errors occurred, such as finishing device upgrade installation at a time not within an acceptable time window as defined by the administrator instructions, and labeling corresponding data as negative. The AI model 235 can refine itself based on the labeled data, e.g., adjust one or more parameters, such that during a subsequent upgrade session the AI model 235 performs differently. For example, based on the feedback mechanism, the AI model 235 may self-refine such that upgrade installation time estimates are larger in future upgrade sessions.

The evaluator service 240 receives an upgrade readiness ruleset from the controller 115 and evaluates upgrade readiness rules of the upgrade readiness ruleset based on local device telemetry data collected by the monitoring services 215. The evaluator service 240 can evaluate various local device telemetry data in view of various upgrade readiness rules, depending on the embodiment, including upgrade readiness rules, telemetry data, and evaluations of telemetry data not explicitly delimited herein, without departing from the principles set forth herein. The evaluator service 240 evaluates each upgrade readiness rule and determines whether local device telemetry data satisfies the upgrade readiness rule, and alerts the coordination service 245 regarding which rules are satisfied and which are not.

As an example, the upgrade readiness ruleset may include an upgrade readiness rule that critical traffic is traffic corresponding to a particular user or a particular application, and the rule is not satisfied if critical traffic to or from the user, or to or from the particular application, is currently or expected by the evaluator service 240 to traverse the network device 200 within a particular time window. The particular time window, in some embodiments, is an estimated device upgrade install time, which can be based on a size of the upgrade file. The evaluator service 240 may evaluate local device telemetry data, e.g., data from within a certain amount of time, such as data collected since a last upgrade readiness status, and determine whether the data indicates critical traffic (e.g., based on DPI as described above). The evaluator service 240 may determine whether critical traffic is expected to traverse the network device 200 within the particular time window based on historic traffic patterns of the user or application learned by the AI model 235. For example, if the user usually has traffic on the network device 200 between noon and 4:00 PM, the AI model 235 may learn this pattern. As such, if a current time of the network device 200 is 2:00 PM, the evaluator service 240 may predict that critical traffic of the user is expected for the next two hours.

As another example, the upgrade readiness ruleset may include an upgrade readiness rule that specifies one or more time requirements, such as days of the year and/or hours of the day, etc., during which the upgrade cannot be installed. As described above, the evaluator service 240 may predict an amount of time necessary to install the upgrade at the network device 200, and determine, in view of the one or more necessary timing requirements, whether the upgrade would satisfy the timing requirements. As a particular example, a timing requirement may be that upgrades can only be installed on weekends, and cannot be installed within three days of a holiday. The evaluator service 240 may determine a current date based on data of the network device 200 and determine whether the current date is a weekend day or within three days of a holiday. In various embodiments, the holidays may be identified in the upgrade readiness rule.

As another example, the upgrade readiness ruleset may include a computing resource usage requirement, which may be specified in terms of a range above or around a device-specific dynamic baseline. Dynamic baselines, as mentioned above, are baseline values for computing resources, such as CPU usage, GPU usage, transitory memory usage, and non-transitory storage medium usage. Dynamic baselines are determined by the evaluator service 240, e.g., using the AI model 235 to evaluate historic local device telemetry data to determine typical usage values for computing resources. A dynamic baseline can include typical usage values for one or more time periods, such as a different typical usage value for a particular computing resource for each minute or hour of the day, day of the week, etc. The evaluator service 240 can update the dynamic baseline for a computing resource by incorporating new local device telemetry data into the dynamic baseline calculation, e.g., once per day, inputting the past 24 hours of telemetry data collected by the monitoring services 215 of the network device 200 to the AI model 235 to adjust one or more dynamic baselines. The upgrade readiness rule can specify a range, such as being satisfied when CPU usage is within ten percent of the dynamic baseline for CPU usage. The evaluator service 240 can determine, based on current and/or recent local device telemetry data, a present CPU usage, and compare the present CPU usage value to the dynamic baseline to determine whether the present CPU usage is within 10% of the dynamic baseline. Similar comparisons can be performed by the evaluator service 240 for other upgrade readiness rules corresponding to different computing resources, depending on the embodiment.

In various embodiments, an upgrade readiness rule corresponding to computing resource usage can be evaluated by the evaluator service 240 using a predicted computing resource usage, e.g., a predicted computing resource usage during a time window (e.g., an expected time to install the upgrade). The evaluator service 240 can use the AI model 235 to perform pattern recognition on historic local device telemetry data and determine usage patterns for one or more computing resources. If the usage pattern for a computing resource corresponding to an upgrade readiness rule indicates a usage value that would fail to satisfy the upgrade readiness rule during the time to install the upgrade, the evaluator service 240 may determine that the upgrade readiness rule is predicted to fail to be satisfied if installation of the upgrade were to initiate presently, and as such may determine that the upgrade readiness rule is not currently satisfied based on the predicted computing resource usage.

As another example, an upgrade readiness rule can include a peer availability requirement that is failed if one or more peer devices in the LAN 105 are down, e.g., unreachable by the device 200. The evaluator service 240 can determine this failing by detecting whether any of the one or more peer devices are down based on local device telemetry data, e.g., recent messages to and from the one or more peer devices. In some embodiments, the evaluator service 240 may send a message to some or all of the one or more devices and wait for a response, where receiving a response from a peer device indicates the peer device is not down, but failing to receive the response within a certain time period indicates the peer device is down.

The coordination service 245 communicates with the controller 115 based on data received from the controller 115 and/or evaluator service 240 to periodically generate and provide upgrade readiness states to the controller 115 and/or control the installation of a device upgrade at the network device 200. In line with a periodicity that can be set by an administrator of the network device 200 or specified in the upgrade readiness ruleset, depending on the embodiment, the coordination service 245 generates upgrade readiness states. If the evaluator service 240 indicates that all upgrade readiness rules are satisfied, the coordination service 245 sends the controller 115 a positive upgrade readiness state. If the evaluator service 240 indicates that not all upgrade readiness rules are satisfied, the coordination service 245 sends the controller 115 a negative upgrade readiness state.

The coordination service 245 receives instructions to initiate an upgrade from the controller 115. In various embodiments, upon receipt, the coordination service 245 instructs the evaluator service 240 to evaluate the upgrade readiness rules. If all upgrade readiness rules are satisfied, the coordination service 245 initiates the upgrade. If one or more upgrade readiness rules are not satisfied, at that time or during subsequent evaluations during installation of the upgrade, the coordination service 245 performs one or more remedial actions. Depending on the embodiment, the remedial actions can include reallocating resources, e.g., allocating a greater amount of computing resources like CPU cycles to essential functionality of the network device 200, such as the networking services 210, and a lesser amount of computing resources to the installation of the upgrade. In some embodiments, the remedial actions can include pausing or cancelling the upgrade. If the coordination service 245 performs a remedial action, it sends a message to the controller 115 indicating the remedial action. When the upgrade installs successfully, the coordination service 245 reports the successful upgrade to the controller 115.

The storage 280 is a data store, such as a relational or non-relational database, that stores data related to device upgrading. In various embodiments, the storage 280 can include one or more upgrade readiness rulesets, one or more baseline values, e.g., dynamic baselines determined by the agent 230, past and/or current upgrade readiness states, and/or any other data related to device upgrading. In some embodiments, the storage 280 is a part of the storage 220, or the storage 220 is part of the storage 280, e.g., in embodiments that do not include a container 225.

Referring to FIG. 3, a diagram 300 depicting various subsets of artificial intelligence in accordance with various embodiments of the disclosure is shown. Artificial intelligence (AI 310) is typically understood in the art to be the development of machines and algorithms that mimic human intelligence, for example, by optimizing actions to achieve certain goals. At its core, AI 310 often involves designing algorithms and models that mimic cognitive functions, such as learning, reasoning, problem-solving, perception, and even language understanding. Unlike traditional computer programs that follow a fixed set of instructions, AI systems have the ability to adapt, improve, and make decisions based on input data and environmental interactions.

AI 310 can be considered a generic term because it encompasses a wide range of subfields and techniques, from simple rule-based systems to advanced machine learning and deep learning models. These AI techniques are used to simulate various aspects of human cognition. For example, machine learning (ML 320) allows computers to learn from data patterns without explicit programming for each task, while natural language processing (NLP) enables machines to understand and generate human language. Deep learning (DL 330), a more advanced branch of AI, uses neural networks to automatically learn complex patterns from large datasets, akin to the human brain's information processing. This versatility makes AI a powerful tool across diverse applications, including image recognition, autonomous driving, voice assistants, healthcare diagnostics, and materials discovery.

A goal of AI is often to create systems that can function autonomously and intelligently in real-world scenarios. As AI 310 continues to evolve, it can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

Within AI 310, Machine Learning (ML 320) can be considered a subset that focuses on the development of algorithms and statistical models that enable computers to learn and make decisions from data without explicit programming. In traditional programming, a computer is given a fixed set of rules to follow, but ML 320 can shift this paradigm by allowing systems to identify patterns, adapt, and improve their performance based on the data they encounter. This data-driven approach makes ML particularly valuable for tasks that are too complex or dynamic to define using straightforward rules, such as, for example, recognizing images, predicting consumer behavior, or diagnosing diseases. In various embodiments described herein, machine-learning methods may be utilized for various purposes, such as determining baselines for determining dynamic resource usage baselines based on local device telemetry data.

ML models can be configured to analyze large amounts of data to identify trends and relationships that inform their predictions or classifications. The process typically involves three stages: training, validation, and testing. During training, the model learns from a dataset by adjusting its internal parameters to minimize errors between its predictions and the actual results. Techniques like linear regression, decision trees, random forests, and Gaussian processes are commonly used in ML 320. These algorithms can handle various data types, including numerical, categorical, and structured datasets like spreadsheets or grids. One of the key strengths of ML is its ability to generalize from the training data to make accurate predictions on new, unseen data. In a number of embodiments described herein, training data may be generated from telemetry data and records of past upgrades, such as past upgrade plans, upgrade readiness states, upgrade deployment instructions, upgrade readiness rulesets, and so on.

However, traditional ML methods rely heavily on feature engineering, wherein human experts manually identify the most relevant features or patterns within the data. For example, when using ML 320 for image recognition, an expert might need to extract features like edges, textures, or color patterns before feeding them into a model. This requirement can limit the scalability of traditional ML approaches, especially when dealing with large, unstructured datasets such as images, text, or graphs. Additionally, ML algorithms may often work best when provided with relatively structured data, and they often need a reasonable number of samples (typically more than one-hundred) to learn effectively.

Within ML 320, Deep Learning (DL 330) can be considered a specialized subset that employs multi-layered artificial neural networks to automatically learn complex patterns and representations from large, often unstructured datasets. Inspired by the way the human brain processes information, DL 330 consists of interconnected layers of “neurons” that can adaptively change as they are exposed to more data. Unlike traditional ML methods, which require manual feature engineering to identify key data characteristics, DL models can automatically extract features directly from raw data, such as images, numerical, text, or molecular structures. This automated feature extraction allows DL 330 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as molecular structures, social networks, or atomic interactions. They can learn the dependencies and relationships within graph-like structures, which is crucial for predicting properties of complex molecules and materials. RNNs and their variants, such as Long Short-Term Memory (LSTM) networks, are suited for sequential data like time series or natural language processing, allowing for the analysis and generation of textual information or the prediction of temporal patterns in scientific research.

One of the defining characteristics of deep learning is its requirement for large datasets (typically over five-hundred samples for example) to effectively train neural networks. The deep, multi-layered structure of these networks enables them to capture highly complex and abstract representations of the data, but it also demands significant computational power. Techniques like Variational Autoencoders (VAEs) and Generative Adversarial Networks (GANs) add to the versatility of DL by enabling the generation of new data samples that resemble the training set, aiding in areas such as materials discovery and synthetic data creation. Deep Reinforcement Learning (DRL) combines neural networks with decision-making processes to solve problems that involve optimization and control, further expanding DL's application potential. In summary, DL's ability to automatically learn from raw, unstructured data and model intricate patterns makes it a powerful tool in AI, particularly for complex domains like image recognition, natural language processing, and materials science.

Artificial Neural networks (ANNs or sometimes just NNs) are often a foundation of a DL system. The basic unit of a neural network is typically the perceptron, which can take inputs, assigns weights to these inputs, and combines them to produce an output. The final output is then passed through an activation function (such as, for example, ReLU, sigmoid, or hyperbolic tangent) to introduce non-linearity, which enables the network to model complex patterns.

Neural networks are typically trained through a process of backpropagation, where the system's predictions are compared against the known output, and a loss function is used to measure the difference between the prediction and the actual result. The network's weights can be adjusted through a process called gradient descent, which can be configured to minimize the loss function over time. However, the training process can be prone to problems like overfitting (where the model performs well on the training data but poorly on new data). To counter this, techniques such as regularization (e.g., regularization, dropout), early stopping, and mini-batches can be utilized to prevent the network from becoming overly specialized to the training set.

CNNs are a specific type of ML neural network designed to work particularly well with spatial data, for example image data. However, CNNs can also work with non-image data, for example, one or more data representations, structured as a vector of features as input data. As those skilled in the art will recognize, CNNs typically use specialized layers known as convolutional layers, which apply filters (also known as kernels) to the input data. These filters slide over the input data, detecting patterns, which are then passed to the next layer for further processing. The advantage of CNNs is their ability to automatically learn and extract relevant features from raw data without the need for manual feature engineering. Furthermore, pooling layers (e.g., max-pooling or average pooling) are often added after convolutional layers to reduce the dimensionality of the data, helping to make the system more efficient while retaining the most important information. After several layers of convolutions and pooling, the CNN can output a prediction, such as determining a similarity of a data representation to a query representation.

Graph Neural Networks (GNNs) can be utilized to operate on graph-based data. In GNNs, information is passed between nodes through edges in a process called message passing. This allows the network to capture dependencies and relationships within the graph structure. The key feature of GNNs is their ability to aggregate information from neighboring nodes, which is required for predicting properties that depend on the current/local structure, such as applicable solution steps to address a customer service ticket based on past customer service data.

Generative models aim to learn the underlying distribution of a dataset and generate new samples that resemble the original data. Two common types of generative models are Variational Autoencoders (VAEs) and Generative Adversarial Networks (GANs). VAEs are often configured to work by encoding data into a lower-dimensional latent space and then decoding it back into its original form. This allows for the generation of new data by sampling points from the latent space.

Similarly, GANs consist of two components: a generator that creates fake/generated data and a discriminator that tries to distinguish between real and fake data. The two components are trained in a competitive process where the generator tries to “fool” the discriminator, leading to increasingly realistic generated data.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as data representations.

In a communication network comprising a plurality of network devices such as gateways, registration servers, switches, routers, etc. DRL can be used in scenarios where an optimal decision needs to be made. The combination of RL and DL can allow for learning from raw data, making it a powerful tool for dynamic and real-time decision-making within the communication network.

Although a specific embodiment for a diagram 300 depicting various subsets of artificial intelligence suitable for carrying out the various steps, processes, methods, and operations described herein is discussed with respect to FIG. 3, any of a variety of systems and/or processes may be utilized in accordance with embodiments of the disclosure.

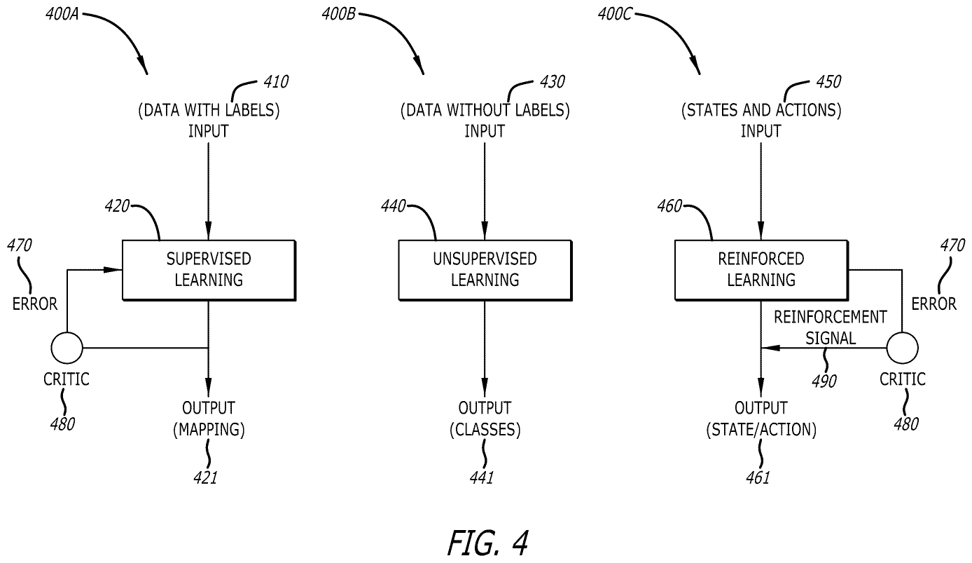

Referring to FIG. 4, different methods of machine-based learning in accordance with various embodiments of the disclosure are shown. In many embodiments, a machine learning model is defined as a mathematical representation of the output of the training process. A machine learning model is often considered similar to computer software designed to recognize patterns or behaviors based on previous experience or data. However, the learning algorithm can discover patterns within the training data, and output an ML model which can capture these patterns and make predictions on new data.

ML models can be understood as a device that has been trained to find patterns within new data and make predictions. These models can be represented as a complex mathematical function that would be impractical for a human to calculate that takes requests in the form of input data, makes predictions on input data, and then provides an output in response. First, these models can be trained over a set of data, and then they are provided an algorithm or other task to reason over data, extract the pattern from feed data and learn from that data. Once the model(s) is/are trained, they can be used to predict a new and previously unseen dataset.

There are various types of machine learning models available based on different business goals and data sets available. Often, based on the desired application, ML models can be configured as or settle into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 4, a supervised learning system 400A is shown. The supervised learning system 400A can be configured with a supervised learning model 420 that accepts input data 410 and generates an output 421. However, the output data is often reviewed by a critic 480 that can determine the presence of an error 470 that can be fed back into the supervised learning model 420 for use in updating.

Supervised learning systems 400A are often considered the simplest machine learning model to understand in which input data (such as training data) has a known label or result as an output. So, the supervised learning model 420 can be understood to work on the principle of input-output pairs. As such, a function can be trained using a training data set, which is then applied to unknown data and makes some predictive performance. Supervised learning is task-based and mostly tested on labeled data sets.

Supervised learning systems 400A may often involve one or more regression problems. In regression problems, the output is a continuous variable. Some commonly used Regression models include linear regression, decision trees, and random forests. Linear regression is typically the most straight forward machine learning model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this may be represented in the form of a line: Y=bx+c. A typical aim of a linear regression-based model can be to find the optimal fit line that best fits the available data points. Linear regression can be extended to multiple linear regressions (finding a plane of best fit in higher dimensional space) and polynomial regressions (finding the best fit curve).

Decision trees are also popular machine learning models that can be used for both regression and classification problems. A decision tree uses a tree-like structure of decisions along with their possible consequences and outcomes. In this, each internal node is used to represent a test on an attribute while each branch is used to represent the outcome of the test. The more nodes a decision tree has, the more accurate the result will be. The advantage of decision trees is that they are intuitive and easy to implement, but may lack accuracy depending on the available computational or time resources available.

Random forests are an ensemble learning method, which may consist of a large number of decision trees. For example, each decision tree in a random forest predicts an outcome, and the prediction with the majority of votes is considered as the outcome. A random forest model can be used for both regression and classification problems. For the classification task, the outcome of the random forest may be taken from the majority of votes. Whereas in the regression task, the outcome can be taken from the mean or average of the predictions generated by each tree.

Classification models are another type of supervised learning, which can be used to generate conclusions from observed values in one or more categorical forms. For example, a classification model can identify if an email is spam or not; whether a certain service ticket is valuable for learning to address customer problems, etc. Classification algorithms can also be used to predict between two or more classes and/or categorize an output into different groups. For these classification systems, a classifier model can be designed that classifies the dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be used to solve various classification problems in machine learning systems. These processes are similar to linear regression but are often used to predict categorical variables. While some variations can be configured to generate a prediction as an output in either “yes” or “no”, 0 or 1, “true” or “false”, etc. However, in some embodiments, the system can instead be configured to not give exact values, but instead provide probabilistic values between zero and one, etc.

Another classification process that can be utilized is a support vector machine (SVM) which is widely used for classification and regression tasks. However, the main aim of SVM is to find the best decision boundaries in an N-dimensional space, which can be utilized to segregate data points into classes, and generate a best decision boundary often known as a hyperplane. SVM processes can select the extreme vector to find a hyperplane, wherein these vectors are known as support vectors.

Naïve Bayes is another popular classification algorithm used in machine learning. This process receives its name as it is based on Bayes theorem and follows the naïve (independent) assumption between the features which is often given as the formula:

$$P ( y \vert X ) = \frac{P ( X \vert y ) * P ( y )}{P ( X )}$$

This formula takes a class or target y and a predictor attribute (X) and calculates a posterior probability P(y|X) of that class given a particular predictor. P(y) is the prior probability of that class, P(X) is the prior probability of the predictor, and P(X|y) is the likelihood or probability of the predictor given the class. As those skilled in the art will recognize, this may be more succinctly understood as the posterior chance being a result of the prior results times the likelihood divided by the evidence available. Each naïve Bayes classifier assumes that the value of a specific variable is independent of any other variable/feature. For example, if a fruit needs to be classified based on color, shape, and taste. So yellow, oval, and sweet will be recognized as mango. Here each feature is independent of other features.

Again, in the embodiment depicted in FIG. 4, an unsupervised learning system 400B is shown. The unsupervised learning system 400B can be configured with an unsupervised learning model 440 that accepts input data 430 and generates an output 441. Unlike other model types, there are no critics or error signals to process. Unsupervised learning models 440 can implement the learning process opposite to supervised learning, which means it enables the model to learn from an unlabeled training dataset. Based on the unlabeled dataset, the unsupervised learning model 440 can predict the output. Using an unsupervised learning system 400B, the unsupervised learning model 440 can learn hidden patterns from the dataset by itself without any supervision. In various embodiments, unsupervised learning models 440 are often utilized to perform tasks involving clustering, association rule learning, and/or dimensional reduction.

Clustering is an unsupervised learning technique that involves clustering or grouping the available data points into different clusters based on similarities and/or differences. The objects or data points with the most similarities remain in the same group, and they have no or very few similarities from other groups. Clustering algorithms can be used in a variety of different tasks such as, but not limited to image segmentation, statistical data analysis, market segmentation, and the like. Some commonly used clustering algorithms that can be selected include K-means Clustering, hierarchal Clustering, DBSCAN, etc.

Association rule learning is an unsupervised learning technique which finds unique relations among variables within a large data set. In many embodiments, a primary aim of this type of learning algorithm is to find the dependency of one data item on another data item and map those variables accordingly so that it can satisfy some desired outcome. This algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and FP-growth algorithm.

In additional embodiments, the number of features/variables present in a dataset can be understood as the dimensionality of the dataset, and the technique used to reduce the dimensionality is known as a dimensionality reduction technique. Although more data provides more accurate results, it can also affect the performance of the model/algorithm, such as yielding overfitting outcomes, etc. In such cases, dimensionality reduction techniques can be utilized. It is often desired that this process involves converting the higher dimensions dataset into lesser dimensions dataset while also ensuring that the ensuing results provide similar information. Different dimensionality reduction methods can be utilized, such as, but not limited to, PCA (Principal Component Analysis), Singular Value Decomposition (SVD), etc.

Finally, in the embodiment depicted in FIG. 4, a reinforcement learning system 400C is shown. The reinforcement learning system 400C can be configured with a reinforcement learning model 460 that accepts input data 450 and generates an output 491. In reinforcement learning, the reinforcement learning model 460 learns actions for a given set of states that lead to a goal state. In the embodiment depicted in FIG. 4, a critic 480 can receive or otherwise notice an error 470 within the reinforcement learning model 460 actions, and adjust the outcome/output, by way of a reinforcement signal 490, such that the “reward” or “punishment” is adjusted to better model the future behaviors or processing of the reinforcement learning model 460.

It is a feedback-based learning model that can takes feedback signals after each state or action by interacting with the environment. This feedback works as a reward (positive for each good action and negative for each bad action), and the agent's goal is to maximize the positive rewards to improve their performance. The behavior of the model in reinforcement learning is similar to human learning, as humans learn things by experiences as feedback and interact with the environment. Popular methods of reinforcement learning including q-learning, state-action-reward-state-action (SARSA), and deep Q network.

Q-learning is one of the popular model-free algorithms of reinforcement learning, which is based on the Bellman equation. It often aims to learn the policy that can help the AI agent to take the best action for maximizing the reward under a specific circumstance. It can incorporate Q values for each state-action pair that indicate the reward to following a given state path, and it tries to maximize that Q-value.

SARSA is an on-policy algorithm based on the Markov decision process. In many embodiments, it can use the action performed by the current policy to learn the Q-value. The SARSA algorithm stands for State Action Reward State Action, which symbolizes the tuple (s, a, r, s′, a′). Finally, deep Q neural networking (or DQN) is Q-learning within a neural network. It can be deployed within a big state space environment where defining a Q-table would be a complex task. So, in these embodiments, rather than using a Q-table, the neural network instead utilizes Q-values for each action based on the state.

Although a specific embodiment for different methods of machine-based learning suitable for carrying out the various steps, processes, methods, and operations described herein is discussed with respect to FIG. 4, any of a variety of systems and/or processes may be utilized in accordance with embodiments of the disclosure.

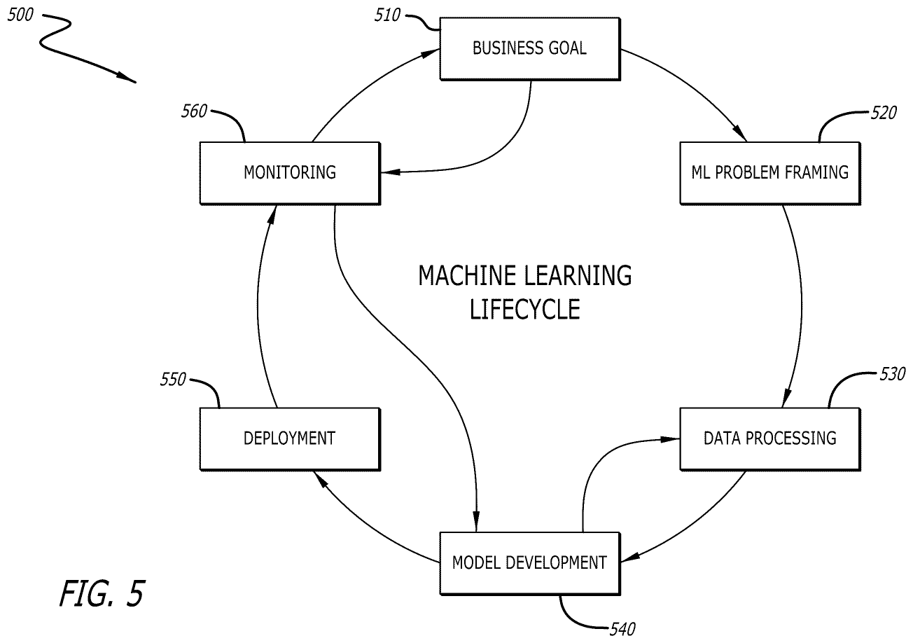

Referring to FIG. 5, a machine learning lifecycle 500 in accordance with various embodiments of the disclosure is shown. During the development of machine learning systems, the embodiment depicted in FIG. 5 can provide a framework for how to structure the design and maintenance of these systems. This machine learning lifecycle 500 outlines various stages involved in building, deploying, and improving ML models to solve real-world problems. By following this structured process, businesses and organizations can ensure that their machine learning projects align with strategic goals, use data effectively, and adapt to changing conditions over time. This machine learning lifecycle 500 emphasizes that developing a machine learning model is not a one-time effort but an iterative process requiring ongoing monitoring and adjustment. The feedback loop inherent in the machine learning lifecycle 500 allows for continual refinement and optimization of models to maintain their accuracy and relevance.

In many embodiments, a first stage of the machine learning lifecycle 500 is identifying the business goal 510, which sets the overall direction and purpose of the ML project. This can involve understanding the specific problems or opportunities within the business or project that machine learning can address. A business goal 510 that is clear can ensure that the project remains focused on delivering tangible value, such as improving LLM-assisted customer service by improving the results generated by the LLM. Without a well-defined goal, it can be challenging to align the subsequent stages of the machine learning lifecycle 500, as the choice of model, data processing methods, and performance metrics can all depend on what the business aims to achieve.

Establishing a business goal 510 that is proper can also involve engaging with key stakeholders and developers to gather requirements and set success criteria. It can provide a roadmap that outlines what success looks like and helps in framing the ML problem. For example, if the goal is to maximize utilization rate of network devices with low carbon footprint, the project might focus on building a predictive model that assigns a higher weightage to carbon footprint and the utilization rate. Clearly defined goals not only help guide the project but also provide benchmarks for evaluating the effectiveness of the deployed model once it enters production.

Once the business goal 510 is established, various embodiments take a next step involving ML problem framing 520, wherein the goal is translated into a specific machine learning task. This can involve selecting the appropriate type of ML problem, such as classification, regression, clustering, or recommendation, and defining the target variables or outputs. Proper problem framing can be important as it determines the particular data requirements, choice of model, and evaluation metrics.

During this stage, it is also prudent to consider the constraints and assumptions that may affect the model's development. This might include data availability, computational resources, ethical considerations, or regulatory compliance. Properly framing the problem ensures that the model development aligns with the business's needs and that the problem is broken down into manageable steps, ultimately increasing the project's chances of success.

Data processing 530 is a step in many embodiments where raw data is collected, cleaned, and transformed into a format suitable for machine learning. This step can involve gathering data from various sources, removing errors or inconsistencies, handling missing values, and normalizing or scaling features to ensure that the model can learn effectively. Feature engineering is often a part of this stage, where new features are derived from the raw data to capture more relevant information and improve model performance.

The quality and preparation of the utilized data can significantly impact the model's accuracy and reliability. Inadequate or poorly processed data can lead to biased or inaccurate predictions, no matter how advanced the model is. Hence, data processing 530 can require or at least benefit from careful planning and iterative refinement. Once the data is processed, it is typically split into training, validation, and test sets to develop and evaluate the model, ensuring that it generalizes well to new, unseen data.

Model development 540 is a phase in a number of embodiments where machine learning algorithms are selected, trained, and refined to create a model that addresses the framed problem. This stage can involve choosing the appropriate algorithm (e.g., decision trees, neural networks, support vector machines), setting up the model's architecture, and defining hyperparameters that will guide the training process. The model is trained on the processed data to identify patterns and relationships that allow it to make predictions or decisions.

During model development 540, the model can be evaluated using the validation dataset to fine-tune its parameters and improve performance. Techniques like cross-validation, regularization, and hyperparameter tuning can be used to prevent overfitting and ensure the model generalizes well. If proper steps are taken, the result is a model that, once it meets predefined performance metrics, is ready for deployment in a real-world environment. However, this process often involves several iterations to optimize the model for the specific business goal, indicated by the arrow back to data processing 530.

In further embodiments, deployment 550 is the stage where the developed model is integrated into the production environment to perform its intended tasks. This phase may involve setting up the necessary infrastructure, such as APIs or cloud-based services, to allow the model(s) to process live data and generate predictions. Deployment 550 can transform the model from a research tool into a functional component of a business process or product, providing real-time insights, automations, or decisions.

Deployment 550 can also be considered proper by setting up mechanisms for logging, error handling, and user access. Since real-world environments are often dynamic and differ from training conditions, deployment may require continuous adaptation and updates to ensure the model(s) operates efficiently. This step can be important because a model's success is not only determined by its performance metrics but also by its ability to provide actionable results that align with the business goal 510.

In more embodiments, monitoring 570 is the ongoing process of tracking the model's performance and behavior after deployment. It involves collecting data on the model's predictions, accuracy, latency, and error rates to detect issues such as concept drift, where changes in the underlying data patterns can degrade the model's accuracy. By continuously monitoring 570, teams can identify when the model's performance drops and requires retraining or adjustments to align with the evolving data.

Monitoring 570 can also encompass aspects like user feedback, security, and compliance, ensuring that the model remains effective, reliable, and ethical in its application. It may serve as the feedback loop in the lifecycle, where insights gained from monitoring feed back into the earlier stages, such as data processing 530 and/or model development 540, to refine the model(s) as needed. This iterative process allows the machine learning system to adapt and maintain its alignment with the business goal 510 over time.

Although a specific embodiment for a machine learning lifecycle 500 suitable for carrying out the various steps, processes, methods, and operations described herein is discussed with respect to FIG. 5, any of a variety of systems and/or processes may be utilized in accordance with embodiments of the disclosure. For example, the particular route of development of the model(s) may not follow this cycle completely.

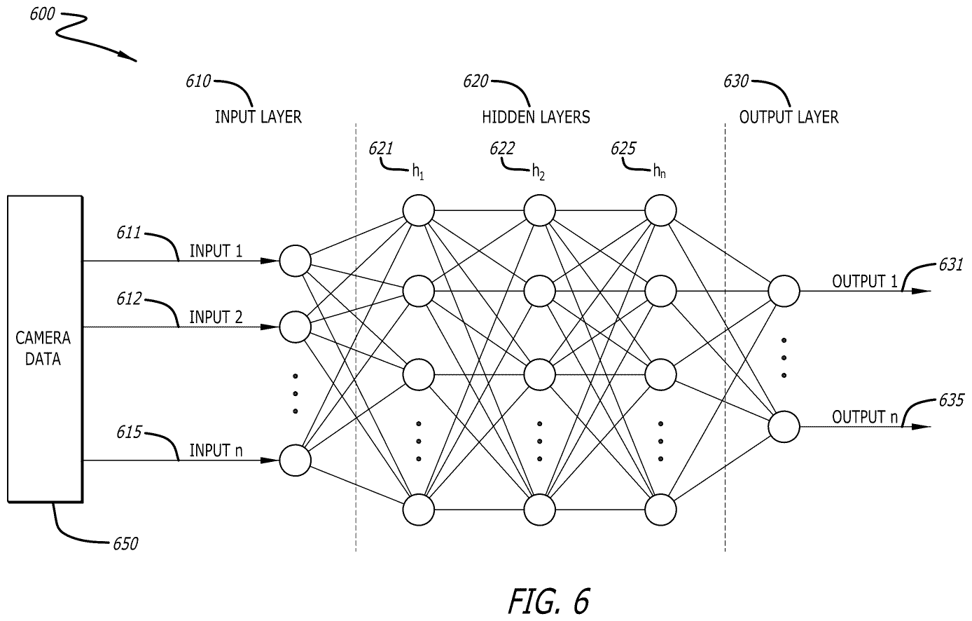

Referring to FIG. 6, a neural network 600 in accordance with various embodiments of the disclosure is shown. The embodiment depicted specifically depicts a feedforward neural network with multiple layers. This type of network consists of an input layer 610, one or more hidden layers 620, and an output layer 630. Each layer contains nodes (or neurons) that are interconnected, representing how data flows through the network. The input layer 610 can receive raw data, which is then processed by the hidden layers 620 through weighted connections and activation functions. These hidden layers 620 can enable the network to learn complex patterns and relationships within the data.

The output layer 630 can produce the network's predictions or classifications based on the processed input. The interconnected nature of the nodes allows the neural network 600 to learn from data during training by adjusting the weights of connections to minimize prediction errors. This structure is the foundation of deep learning models, as adding more hidden layers 620 can create a deep neural network, capable of tackling highly complex tasks such as image recognition, natural language processing, and pattern detection in large datasets.

A perceptron or a single artificial neuron is the building block of artificial neural networks (ANNs) and can perform forward propagation of information. For a set of inputs to the perceptron, weights (and biases to shift wights) can be assigned. These inputs and weights can be multiplied out correspondingly together to get a sum output. Those skilled in the art will recognize tools such as, but not limited to, PyTorch, Tensorflow, and MXNet as training packages for common neural network tasks. However, it is contemplated that other tools may be developed specifically for the neural network tasks related to the embodiments described herein.

In additional embodiments, the weight matrices of a neural network can be initialized randomly or obtained from a pre-trained model. These weight matrices can be multiplied with the input matrix (or output from a previous layer) and subjected to a nonlinear activation function to yield updated representations, which are often referred to as activations or feature maps. The loss function (also known as an objective function or empirical risk) can often be calculated by comparing the output of the neural network and the known target value data.

Feedforward networks, such as the neural network 600 depicted in the embodiment of FIG. 6, are often configured as neural networks where information moves in one direction, from the input layer through the hidden layers to the output layer, without any cycles or loops. They are primarily used for tasks such as classification, regression, and simple pattern recognition, where each input is processed independently of others. In contrast, backpropagation is not a separate type of network but rather a training algorithm commonly used in both feedforward and other types of networks, like recurrent neural networks (RNNs).

Backpropagation involves adjusting the weights of the network in the reverse direction (from output to input) based on the error between the predicted output and the actual target during training. While feedforward describes the structure and data flow within the network, backpropagation is a technique used to optimize the model. Feedforward networks are ideal for straightforward tasks where input-output relationships are not sequential or time-dependent. However, for problems involving learning complex patterns over time, networks that leverage backpropagation for training, like RNNs or deep feedforward networks with many hidden layers, become necessary to capture these intricate dependencies.

Typically, in these network arrangements, the weights are iteratively updated via various methods including, but not limited to, stochastic gradient descent algorithms in order to help minimize the loss function until the desired accuracy is achieved. Most modern deep learning frameworks can facilitate this by using reverse-mode automatic differentiation to obtain the partial derivatives of the loss function with respect to each network parameter through recursive application of the chain rule. Colloquially, this is also known as back-propagation. Common gradient descent algorithms can include, but are not limited to, Stochastic Gradient Descent (SGD), Adam, Adagrad etc. The learning rate is an important parameter in gradient descent. Except for SGD, all other methods use adaptive learning parameter tuning. Depending on the objective such as classification or regression, different loss functions such as Binary Cross Entropy (BCE), Negative Log Likelihood Loss (NLLL) or Mean Squared Error (MSE) can be used.

Neural network architecture is commonly used for a wide range of tasks in fields such as computer vision, natural language processing, financial forecasting, and materials science. For instance, it can be employed to recognize patterns in images, such as identifying objects or faces, or to classify text into categories, like spam detection in emails. It is also useful in regression problems, such as predicting stock prices or energy consumption, where input features can be processed to output continuous values. However, this is a general example of an artificial intelligence (AI) model, illustrating how a feedforward neural network works. Depending on the problem, other methods and models may be more appropriate. For example, convolutional neural networks (CNNs) are often used for image processing tasks, while recurrent neural networks (RNNs) are suitable for sequential data like time series data or text. Additionally, simpler models like linear regression, decision trees, or support vector machines (SVMs) may be sufficient if the problem is less complex, or the dataset is relatively small. The embodiment depicted in FIG. 6 is presented as an exemplary ML solution that may be deployed within one or more methods or systems described herein.

In many embodiments, the input layer 610 is the first layer in a neural network 600 and serves as the initial point where raw data is introduced into the model. Each node (or neuron) in this layer represents an individual feature or variable from the dataset, allowing the network to receive and process various types of data, such as pixel values in an image, numerical features (e.g., KPIs of network device) in a spreadsheet, or words in a text document. The number of nodes in the input layer directly depends on the number of features present in the dataset. If there are one-hundred features in the data, the input layer will typically have one-hundred nodes, each conveying one piece of the information to the subsequent layers. In more embodiments, the inputs of the neural network 600 are generally scaled i.e., normalized to have a zero mean and/or unit standard deviation. Scaling can also be applied to the input of hidden layers (using batch or layer normalization) to improve the stability of neural network 600.

Unlike the hidden layers 620 and output layer 630, the input layer 610 typically does not perform any computations or transformations on the data. Its primary function is often to pass the input data to the next layer in the network, the first hidden layer 621. However, it is often desired that the data fed into this layer is preprocessed appropriately, such as being normalized or standardized, to ensure that the neural network can learn efficiently. Proper preprocessing, like scaling numerical values or encoding categorical variables, can help the network process data uniformly, facilitating more stable and faster convergence during training.

The input layer's design depends on the nature of the problem. For example, in natural language processing, the input layer may represent words encoded as numerical vectors, while in time-series analysis, each node might represent a data point in a sequence. While the input layer 610 itself does not modify the data, it sets the stage for the neural network to extract complex patterns and relationships through the deeper layers. This flexibility in handling various types of input make the neural network 600 a powerful tool for a diverse set of applications.

With respect to the embodiments described herein, the input layer may be configured with a plurality of inputs providing data 650. For example, a model can be configured with a first input 611 configured as a user query, a second input 612 is configured with a first data representation from the context data store, while additional inputs can be added related to the number of data representations. The nth input 615 can be configured in certain embodiments to include an N^{th} attribute. Those skilled in the art will recognize that the inputs can be configured to include various data.

In a number of embodiments, the neural network 600 comprises a plurality of hidden layers 620. The embodiment depicted in FIG. 6 comprises a first hidden layer 621, a second hidden layer 622, and an nth hidden layer 625, which are denoted as h₁, h₂, and hₙ respectively. In many embodiments, the hidden layers 620 are where the core of the model's learning and pattern recognition occurs. In each hidden layer, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the network to capture complex patterns in the data that simple linear models cannot. The intricate web of connections among neurons across layers helps the network transform and process input features into representations that become progressively more abstract and useful for making predictions.

The first hidden layer 621 h₁ receives direct input from the input layer, transforming the raw data into an initial set of features. For example, in an image recognition task, this layer might begin identifying basic patterns, such as edges or simple textures. The output of the first hidden layer 621 is then passed to a second hidden layer 622 h₂, which builds upon the features identified by the first hidden layer 621. This deeper layer might start recognizing more complex patterns, such as shapes or specific object components, by combining the lower-level features identified earlier. This can continue on until a last, nth hidden layer 625 hₙ continues this abstraction process, allowing the network to recognize even higher-level, more detailed features, such as identifying an entire object within an image or understanding intricate relationships in the input data.

Each hidden layer adds a level of complexity and abstraction to the network's learning capabilities. The multi-layer structure can enable the network to move from recognizing simple patterns in the first hidden layer 621 to highly complex, abstract concepts in the deeper layers. The number of hidden layers and neurons within them can vary depending on the problem's complexity. More hidden layers generally allow the network to model more intricate functions, making deep neural networks especially effective for tasks like image recognition, natural language processing, and complex predictive modeling. However, adding more layers also increases the computational demand and the risk of overfitting, highlighting the need to carefully design and tune these hidden layers for optimal performance.

In various embodiments, the output layer 630 is often the final layer in a neural network and is responsible for producing the network's predictions or classifications based on the information processed through the previous hidden layers 620. Each neuron in the output layer 630 can represent a specific outcome or category that the model can predict. In the embodiment depicted in FIG. 6, the outputs are labeled as “output 1” 631 to “output n” 635, indicating that the network can be designed to have a varying number of outputs depending on the nature of the problem being solved for. For example, in a binary classification task, there would typically be a single output neuron that provides a probability score for one of the two classes/outcomes. In contrast, for multi-class classification, the output layer would contain multiple neurons, each corresponding to a different class.

The number of neurons in the output layer 630 can also designed specifically for other types of tasks, such as regression, where the model can predict continuous values. In such cases, the output layer 630 might contain a single neuron representing a numerical prediction, such as the price of a house or the temperature forecast, etc. Alternatively, in complex applications like multi-label classification (where each input can belong to multiple classes simultaneously), the output layer 630 could have multiple neurons, each representing a different class, with each neuron outputting a probability of the input belonging to that specific class.

The activation function used in the output layer can vary based on the desired output. For binary classification, a sigmoid function is commonly used to produce a probability between 0 and 1. For multi-class classifications, a softmax function can be applied to output a set of probabilities that sum to 1, indicating the most likely class. For regression problems, a linear activation function is often used to output a continuous range of values. The flexibility in designing the output layer allows the neural network 600 to be applied to a wide variety of tasks, from simple binary decisions to complex multi-output predictions, making them a versatile tool in artificial intelligence and machine learning.

In several additional embodiments, a system may utilize the neural network 600 to generate responses to user queries. Over time, the neural network 600 can adjust routing algorithms based on feedback.

Although a specific embodiment for an exemplary neural network suitable for carrying out the various steps, processes, methods, and operations described herein is discussed with respect to FIG. 6, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 6, which is an illustrative example meant to make it easier to explain the basic concepts of neural networks and how they process information.

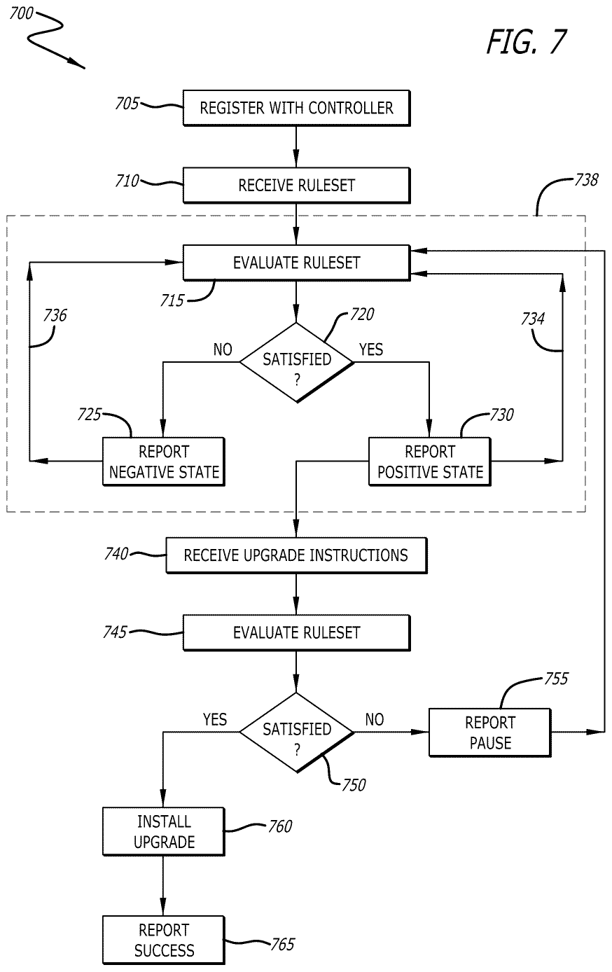

Referring to FIG. 7, a flowchart depicting a process 700 of a local upgrade agent in accordance with various embodiments of the disclosure is shown. The process 700 includes multiple steps indicated at blocks in the flowchart. Depending upon the embodiment, the process 700 can include fewer, additional, or other steps than those illustrated in the figure. The local upgrade agent may be, for example, the agent 230 of network device 200.

The local upgrade agent registers with a controller (block 705). In various embodiments, the local upgrade agent, upon commencing operation, attempts to communicate with the controller. For example, the local upgrade agent may include an address of the controller. Upon registration, the local upgrade agent establishes a communicative coupling with the controller, such as an SSH tunnel. The local upgrade agent receives a ruleset, e.g., an upgrade readiness ruleset, from the controller (block 710). This may occur, for example, after initiation of the communicative coupling.

The local upgrade agent evaluates the ruleset (block 715). In many embodiments, the local upgrade agent evaluates the ruleset periodically. The local upgrade agent evaluates the ruleset based on local device telemetry data, e.g., data collected by one or more monitoring services at the device hosting the local upgrade agent. The local upgrade agent determines whether all rules (e.g., upgrade readiness rules) of the ruleset are satisfied (block 720). If not, the local upgrade agent reports a negative state (e.g., a negative upgrade readiness state) to the controller (block 725). Alternatively, if the ruleset is satisfied, the local upgrade agent reports a positive state (e.g., a positive upgrade readiness state) to the controller (block 730). As described, this loop of evaluating and reporting may be performed periodically (block 738).

At some point, after reporting a positive state, the local upgrade agent receives upgrade instructions from the controller (block 740). The local upgrade agent again evaluates the ruleset using local device telemetry data (block 745). Based on the evaluation, the local upgrade agent determines whether the ruleset is satisfied and installation of the upgrade can commence (block 750). If the ruleset is not satisfied, the local device upgrade agent can pause the upgrade or performs another remedial action, and reports the remedial action to the controller (block 755). The pause may be done immediately, but in some embodiments, the pause may occur after the current operation, while still other embodiments may initiate the pause after generating one or more reports or sent indications that the pause will occur. The local device upgrade then returns to periodically evaluating the ruleset and reporting a state to the controller (block 738). If the ruleset is instead satisfied, the local device upgrade agent installs the upgrade (block 760). Upon success of the installation of the upgrade, the local upgrade agent reports the successful upgrade to the controller (block 765).

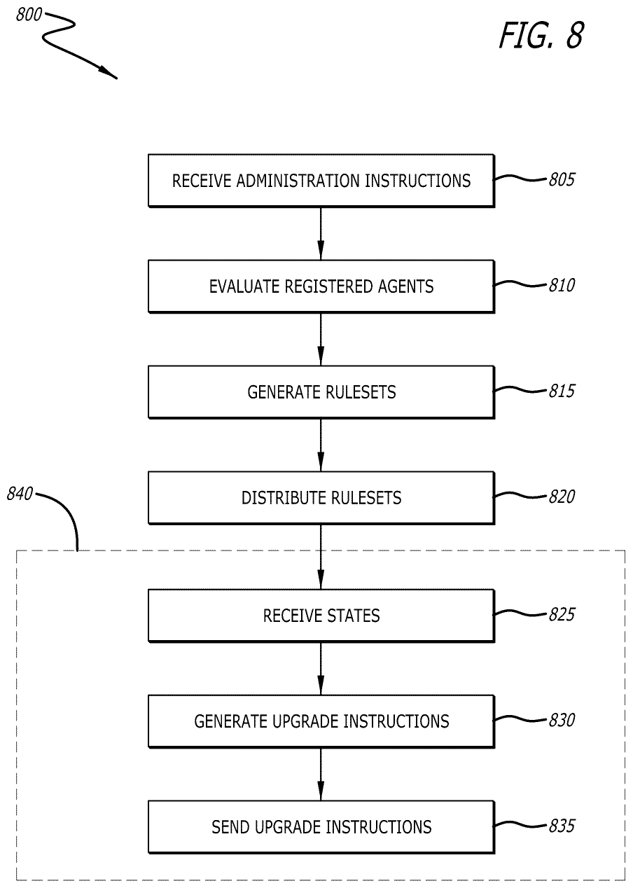

Referring to FIG. 8, a flowchart depicting a process 800 of a device upgrade controller in accordance with various embodiments of the disclosure is shown. The process 800 includes multiple steps indicated at blocks in the flowchart. Depending upon the embodiment, the process 800 can include fewer, additional, or other steps than those illustrated in the figure. The device upgrade controller may be, for example, the controller 115.

The device upgrade controller receives administration instructions (block 805). For example, the device upgrade controller may receive administration instructions from a user device of an administrator, where the administration instructions indicate parameters of one or more upgrade readiness rules for an upgrade session. The administration rules can include requirements for device-specific upgrade readiness rules. In such embodiments, the device upgrade controller evaluates local upgrade agents that are registered with the device upgrade controller (block 810). By way of the evaluation, the device upgrade controller collects device-specific details to inform the device-specific upgrade readiness rules, particularly when generating upgrade readiness rulesets for each local upgrade agent. The device upgrade controller generates the rulesets (block 815). Some or all of the rulesets can be device-specific, e.g., may include one or more rules because of device-specific details evaluated by the device upgrade controller.

The device upgrade controller distributes the rulesets to the local upgrade agents (block 820). Thereafter, the device upgrade controller enters a feedback loop with the local upgrade agents until the upgrade session is complete (block 840). Within the feedback loop, the device upgrade controller periodically receives states, e.g., upgrade readiness states, from the local upgrade agents (block 825). Each state indicates whether or not the device corresponding to the local upgrade agent that sent the state satisfies all the rules of the ruleset sent to the local upgrade agent. Based on the received states, the device upgrade controller generates upgrade instructions (block 830). For example, in view of a subset of local upgrade agents that report a positive state, the device upgrade controller generates upgrade instructions for one or more of the devices that correspond to the subset of local upgrade agents. The device upgrade controller sends the upgrade instructions to the respective devices (block 835). As the device upgrade controller receives subsequent states, the device upgrade controller may adjust the upgrade plan, such as generating new upgrade instructions and sending the new upgrade instructions to one or more devices. If a particular device, e.g., a device previously sent upgrade instructions, reports a negative state and/or a remedial action, the device upgrade controller may adjust the upgrade plan by cancelling or excluding the upgrade instructions sent to that device and may send new upgrade instructions to a different device. Based on this feedback loop, which allows for adjustments to the upgrade plan based on real-time state updates from devices to be upgraded, the device upgrade controller can dynamically upgrade the devices while minimizing risks by upgrading devices when they satisfy their respective rulesets, satisfaction or fulfilment of which indicates upgrade readiness.

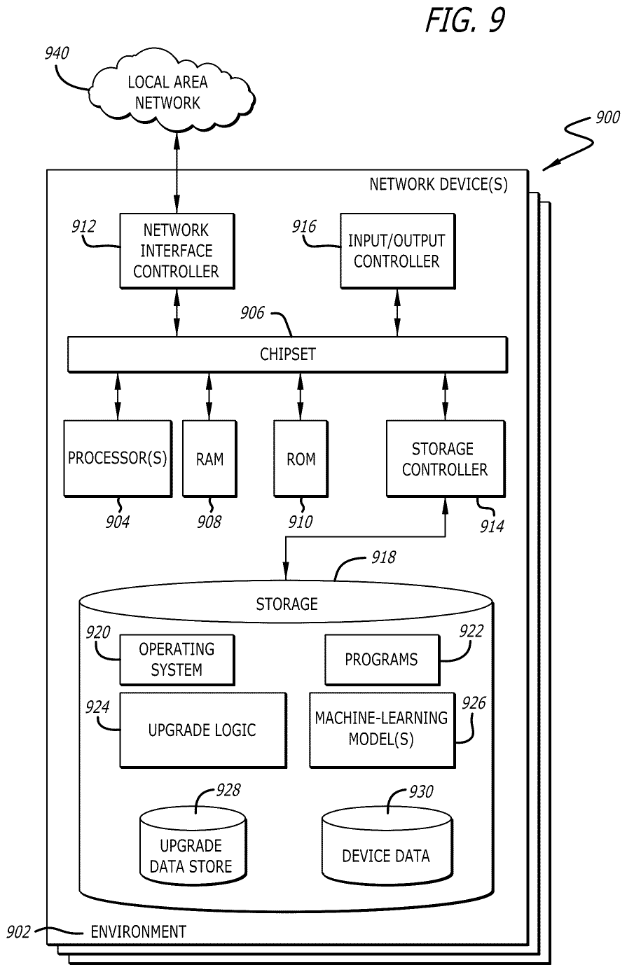

Referring to FIG. 9, a conceptual block diagram of a device 900 suitable for configuration with upgrade logic in accordance with various embodiments of the disclosure is shown. The embodiment of the conceptual block diagram depicted in FIG. 9 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 9 can also illustrate an access point, a switch, or a router in accordance with various embodiments of the disclosure. The device 900 may, in many nonlimiting examples, correspond to physical devices or to virtual resources described herein. For example, in some embodiments, the device 900 may be a set of devices, such as a collection of servers of a hyperscaler that collectively provide cloud services, such as hosting the upgrade logic. In various embodiments, the upgrade logic can include some or all of the control logic and/or the agent logic described above.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, processor(s) 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In a number of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (shown as ROM 910) or non-volatile RAM (“NVRAM”) for storing basic routines thereon that can help with various tasks such as, but not limited to, starting up the device 900 and/or transferring information between the various components and devices. The ROM 910 or NVRAM can also store other application components necessary for the operation of the device 900 in accordance with various embodiments described herein.

Additional embodiments of the device 900 can be configured to operate in a networked environment using logical connections to remote computing devices and computer systems through a network, such as the network 940. The chipset 906 can include functionality for providing network connectivity through a network interface controller 912. Those skilled in the art will recognize that a network interface controller 912 may also be commonly referred to as a network interface card or “NIC”, which may comprise a gigabit Ethernet adapter or similar component. The network interface controller 912 can be capable of connecting the device 900 to other devices over the network 940. It is contemplated that the device 900 is not limited to a single port containing a network interface controller 912 and that more may be present in the device 900, connecting the device to other types of networks and remote systems.

In further embodiments, the device 900 can be connected to a storage 918 that provides non-volatile storage for data accessible by the device 900. The storage 918 can, for instance, store an operating system 920, programs 922, an upgrade data store 928, and device data 930 which are described in greater detail below. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

In many more embodiments, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more instances of a device 900 operating in a cloud-based arrangement. By way of example, and not limitation, computer-readable storage media can include volatile and non-volatile, removable and non-removable media implemented in any method or technology.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In many additional embodiments, the storage 918 or other computer-readable storage media is encoded with computer-executable instructions which, when loaded into the device 900, may transform it from a general-purpose computing system into a special-purpose computer capable of implementing the embodiments described herein. These computer executable instructions may be stored as program 922 (for example, an application) and transform the device 900 by specifying how the processor(s) 904 can transition between states, as described above. In some embodiments, the device 900 has access to computer-readable storage media storing computer executable instructions which, when executed by the device 900, perform the various processes described above. In certain embodiments, the device 900 can also include computer-readable storage media having instructions stored thereupon for performing any of the other computer-implemented operations described herein.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor display, a flat panel display, a portable display, a digital projector, a printer, or other type of output device. Those skilled in the art will recognize that the device 900 might not include all of the components shown in FIG. 9 and can include other components that are not explicitly shown in FIG. 9 or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

In many further embodiments, the device 900 may include an upgrade logic 924. The upgrade logic 924 can be configured to perform one or more of the various steps, processes, operations, and/or other methods that are described above. Often, the upgrade logic 924 can be a set of instructions stored within a non-volatile memory that, when executed by the processor(s) 904 can carry out these steps, etc. In numerous embodiments, the upgrade logic 924 may perform various operations related to upgrading devices in a computing environment, such as some or all operations described herein. In some embodiments, the device 900 can be a server device. In various embodiments, the storage 918 can include the upgrade data store 928. The upgrade data store 928 may be a relational or non-relational database or other data storage system to store data related to dynamic upgrades, such as rulesets and baselines.

In a number of embodiments, the storage 918 can include device data 930. The device data 930 may refer to machine-specific data of the device 900, such as locally stored files, as well as telemetry data of the device 900. In various embodiments, the device data 930 can be gathered by the upgrade logic 924.

Finally, in numerous additional embodiments, data may be processed into a format usable by one or more ML model(s) 926 (shown as machine-learning model(s)) (e.g., feature vectors), and or other pre-processing techniques. The ML model(s) 926 may be any type of ML model, such as supervised models, reinforcement models, and/or unsupervised models. The ML model(s) 926 may include one or more of linear regression models, logistic regression models, decision trees, Naïve Bayes models, neural networks, k-means cluster models, random forest models, and/or other types of ML model(s) 926. In various embodiments, the ML model(s) 926 is the AI model 235.

The ML model(s) 926 can be configured to generate inferences to make predictions or draw conclusions from data. An inference can be considered the output of a process of applying a model to new data. This can occur by learning from at least telemetry data and an upgrade readiness ruleset as described above, and utilizing the learning to produce output, such as upgrade readiness states. For example, the ML model(s) 926 can be utilized for determining upgrade readiness states by evaluating local device telemetry data in view of an upgrade readiness ruleset.

Once trained, the ML model(s) 926 may be integrated into the device 900 to periodically evaluate local device telemetry data and generate upgrade readiness states, and sometimes to decide whether to install an upgrade when instructed to do so. To generate an upgrade readiness state, the trained model can take input data and produce a prediction or a decision. The input data can be in various forms, depending upon the embodiment, depending on the type of problem the model was trained to solve. The output of the model can also vary depending on embodiment and the problem, such as text and/or numerical data.

Although a specific embodiment for a device suitable for configuration with an upgrade logic for carrying out the various steps, processes, methods, and operations described herein is discussed with respect to FIG. 9, any of a variety of systems and/or processes may be utilized in accordance with embodiments of the disclosure. For example, the device may be in a virtual environment such as a cloud-based network administration suite, or it may be distributed across a variety of devices.

Although the present disclosure has been described in certain specific aspects, many additional modifications and variations would be apparent to those skilled in the art. In particular, any of the various processes described above can be performed in alternative sequences and/or in parallel (on the same or different computing devices) in order to achieve similar results in a manner that is more appropriate to the requirements of a specific application. It is therefore to be understood that the present disclosure can be practiced other than specifically described without departing from the scope of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the scope of the present disclosure, as set forth in the appended claims, as might be apparent to those of ordinary skill in the art, are also encompassed by the present disclosure.

What is claimed is:

1. A network device, comprising:
a processor; and
a non-transitory computer-readable storage medium having stored thereon logic that, when executed by the processor, causes performance of operations comprising:
receiving, from a controller, an upgrade readiness ruleset, wherein the upgrade readiness ruleset comprises a plurality of upgrade readiness rules;
evaluating, by an upgrade agent local to the network device, the upgrade readiness ruleset based on local telemetry data of the network device, resulting in an upgrade readiness state, wherein the evaluating is performed periodically by the upgrade agent;
reporting, by the upgrade agent, to the controller, the upgrade readiness state;
receiving, from the controller, instructions to initiate an upgrade;
determining, by the upgrade agent, based on a subsequent periodic evaluation of local telemetry data, that current local telemetry data fails to satisfy a particular upgrade readiness rule of the plurality of upgrade readiness rules; and
responsive to determining that current local telemetry data fails to satisfy the particular upgrade readiness rule, pausing, by the upgrade agent, the upgrade.

2. The network device of claim 1, the operations further comprising:
reporting, by the upgrade agent, to the controller, a pause of the upgrade;
determining, by the upgrade agent, at a second subsequent periodic evaluation of local telemetry data, that all upgrade readiness rules of the upgrade readiness ruleset are satisfied, resulting in a new upgrade readiness state;
reporting, by the upgrade agent, to the controller, the new upgrade readiness state;
receiving, by the upgrade agent, from the controller, new instructions to initiate the upgrade; and
responsive to receiving the new instructions to initiate the upgrade and fulfilment of all upgrade readiness rules, initiating, by the upgrade agent, the upgrade on the network device.

3. The network device of claim 1, wherein evaluating, by the upgrade agent local to the network device, the upgrade readiness ruleset based on the local telemetry data of the network device, resulting in the upgrade readiness state, comprises:
monitoring, by the upgrade agent, critical user traffic and critical application traffic, wherein the upgrade readiness ruleset identifies at least one of a user and an application as critical;
wherein determining, by the upgrade agent, based on the subsequent periodic evaluation of the local telemetry data, that the current local telemetry data fails to satisfy the particular upgrade readiness rule of the plurality of upgrade readiness rules, comprises at least one of:
determining, by the upgrade agent, that the critical user traffic and critical application traffic is currently traversing the network device, and
predicting, by the upgrade agent, that the critical user traffic and critical application traffic will occur within a period of time that fails a timing requirement of the particular upgrade readiness rule.

4. The network device of claim 1, wherein determining, by the upgrade agent, based on the subsequent periodic evaluation of the local telemetry data, that the current local telemetry data fails to satisfy the particular upgrade readiness rule of the plurality of upgrade readiness rules, comprises:
predicting, by the upgrade agent, an amount of time necessary to install the upgrade on the network device; and
determining, by the upgrade agent, based on a timing requirement included in the particular upgrade readiness rule, that installing the upgrade would fail to satisfy the timing requirement.

5. The network device of claim 1, wherein evaluation of the particular upgrade readiness rule of the upgrade readiness ruleset is based on a dynamic baseline value determined by the upgrade agent based on historic local telemetry data of the network device.

6. The network device of claim 5, wherein the dynamic baseline value corresponds to one of a processor usage, a transitory memory usage, and a non-transitory storage medium usage; and wherein determining, by the upgrade agent, based on the subsequent periodic evaluation of the local telemetry data, that the current local telemetry data fails to satisfy the particular upgrade readiness rule of the plurality of upgrade readiness rules, comprises:
determining, by the upgrade agent, whether a current usage of one of the processor, transitory memory, and non-transitory storage medium exceeds the dynamic baseline value by at least a threshold amount.

7. The network device of claim 1, wherein the particular upgrade readiness rule comprises a peer availability requirement, the peer availability requirement is failed if a peer device is down, and determining, by the upgrade agent, based on the subsequent periodic evaluation of the local telemetry data, that the current local telemetry data fails to satisfy the particular upgrade readiness rule of the plurality of upgrade readiness rules, comprises:
determining, by the upgrade agent, that the peer device is down.

8. The network device of claim 1, wherein the upgrade agent comprises an agentic artificial intelligence service operating locally on the network device.

9. The network device of claim 8, the operations further comprising:
evaluating, by the upgrade agent, at least a portion of the operations performed by the processor; and
adjusting, by the upgrade agent, based on the portion of the operations, one or more parameters of the upgrade agent.

10. A device upgrade controller, comprising:
a processor; and
a non-transitory computer-readable storage medium having stored thereon logic that, when executed by the processor, causes performance of operations comprising:
receiving administrator instructions to upgrade a plurality of computing devices in a computing environment;
generating, based on the administrator instructions and device-specific details of the plurality of computing devices, a plurality of upgrade readiness rulesets corresponding to the plurality of computing devices;
distributing the plurality of upgrade readiness rulesets to the plurality of computing devices;
receiving, from a plurality of upgrade agents local to the plurality of computing devices, respective upgrade readiness states, wherein the plurality of upgrade agents evaluate the plurality of upgrade readiness rulesets based on local telemetry data of the plurality of computing devices;
generating, based on the received upgrade readiness states, initial upgrade deployment instructions; and
sending, to at least one computing device of the plurality of computing devices, the initial upgrade deployment instructions.

11. The device upgrade controller of claim 10, the operations further comprising:
receiving one or more subsequent upgrade readiness states from one or more computing devices of the plurality of computing devices;
adjusting the initial upgrade deployment instructions based on the received one or more subsequent upgrade readiness states, resulting in adjusted upgrade deployment instructions; and
sending, to a particular computing device of the plurality of computing devices, the adjusted upgrade deployment instructions.

12. The device upgrade controller of claim 10, wherein generating, based on the received upgrade readiness states, the initial upgrade deployment instructions, comprises determining, based on the device-specific details, that a first computing device and a second computing device of the plurality of computing devices cannot be down simultaneously, wherein the initial upgrade deployment instructions are sent to the first computing device and not to the second computing device, and wherein the operations further comprise:
receiving, from the first computing device, a message indicating an upgrade is complete; and
subsequent to receiving the message from the first computing device, sending, to the second computing device, upgrade deployment instructions.

13. The device upgrade controller of claim 10, the operations further comprising:
generating an upgrade progress visualization that comprises a plurality of graphical elements representing the plurality of computing devices, a plurality of graphical elements representing the received upgrade readiness states, and a plurality of graphical elements corresponding to the plurality of computing devices and each indicating whether a computing device has successfully installed an upgrade;
presenting a generated visualization on a display; and
updating the generated visualization periodically based on subsequent upgrade readiness states.

14. The device upgrade controller of claim 10, wherein the device-specific details of each of the plurality of computing devices comprise one or more of a device type, a device placement, a device use case, and a set of dependencies of a device.

15. The device upgrade controller of claim 10, wherein the operations further comprise:
receiving, from the plurality of upgrade agents, topological device-specific details comprising topological telemetry data indicating peer connections among the plurality of computing devices; and
identifying, based on the topological device-specific details, a set of dependencies among the plurality of computing devices;
wherein generating, based on the received upgrade readiness states, the initial upgrade deployment instructions, is further based on the set of dependencies.

16. The device upgrade controller of claim 10, wherein the device upgrade controller comprises an agentic artificial intelligence service operating locally on the device upgrade controller, the operations further comprising:
evaluating, by the device upgrade controller, a portion of the operations performed by the processor; and
adjusting, by the device upgrade controller, based on the portion of the operations, one or more parameters of the agentic artificial intelligence service.

17. A network system, comprising:
a device upgrade controller, the device upgrade controller comprising a first processor and a non-transitory computer-readable storage medium having stored thereon logic that, when executed by the first processor, causes performance of control operations comprising:
generating a plurality of upgrade readiness rulesets corresponding to a plurality of computing devices, wherein each upgrade readiness ruleset of the plurality of upgrade readiness rulesets comprises a plurality of upgrade readiness rules;
distributing the plurality of upgrade readiness rulesets to the plurality of computing devices;
receiving upgrade readiness states from the plurality of computing devices;
generating, based on the upgrade readiness states, upgrade deployment instructions;
receiving a subsequent upgrade readiness state from a particular computing device of the plurality of computing devices;
adjusting the upgrade deployment instructions based on the subsequent upgrade readiness state; and
the plurality of computing devices, wherein each computing device of the plurality of computing devices comprises a respective processor and a non-transitory computer-readable storage medium having stored thereon logic that, when executed by the respective processor, causes performance of agent operations comprising:
evaluating, by an upgrade agent local to a computing device of the plurality of computing devices, a corresponding upgrade readiness ruleset of the plurality of upgrade readiness rulesets, based on local telemetry data of the computing device, resulting in an upgrade readiness state, wherein the evaluating is performed periodically by the upgrade agent, resulting in periodic upgrade readiness states; and
reporting, by the upgrade agent, the periodic upgrade readiness states to the device upgrade controller.

18. The network system of claim 17, wherein generating the upgrade deployment instructions comprises:
identifying, based on a topology of the network system, that a particular application is accessible only through a subset of computing devices of the plurality of computing devices;
generating a first set of upgrade deployment instructions excluding at least one computing device of the subset of computing devices; and
responsive to determining that the subset of computing devices, besides the at least one computing device, upgraded successfully, generating a second set of upgrade deployment instructions for the at least one computing device.

19. The network system of claim 17, wherein, for each computing device of the plurality of computing devices, the evaluating the corresponding upgrade readiness ruleset comprises:
for each upgrade readiness rule of the corresponding upgrade readiness ruleset, determining whether corresponding local telemetry data of the computing device satisfies an upgrade readiness rule; and
wherein satisfaction of all upgrade readiness rules of the corresponding upgrade readiness ruleset corresponds to a positive upgrade readiness state indicating a network device is ready to install an upgrade;
wherein satisfaction of fewer than all upgrade readiness rules of the corresponding upgrade readiness ruleset corresponds to a negative upgrade readiness state indicating the network device is not ready to install the upgrade.

20. The network system of claim 17, wherein each upgrade agent is containerized on a respective computing device of the plurality of computing devices.
